(19) United States
(12) Patent Application Publication
(10) Pub. No.: US 2026/0023673 A1
(43) Pub. Date: Jan. 22, 2026

(54) ARTIFICIAL INTELLIGENCE-BASED SOFTWARE TEST CODE MIGRATION REFINEMENT

(71) Applicant: The Toronto-Dominion Bank, Toronto (CA)

(72) Inventors: Firas Faraj Allah Khidir Kudsy, Brampton (CA); Babatunde Adeyinka Kassim, Mississauga (CA); Nandhini Shankar, Mississauga (CA); Aayush Kathuria, Brampton (CA)

(73) Assignee: The Toronto-Dominion Bank, Toronto (CA)

(21) Appl. No.: 18/777,710

(22) Filed: Jul. 19, 2024

(51) Int. Cl. G06F 11/36; G06F 8/41

(52) U.S. Cl. CPC G06F 11/3604; G06F 8/447

(57) ABSTRACT

An example operation may include one or more of storing verification criteria associated with at least one of a first automation framework and a second automation framework in a memory device, converting a script associated with the first automation framework into a converted script associated with the second automation framework based on execution of a first artificial intelligence (AI) model on a prompt and the script, performing a comparison of the converted script to the verification, determining that the converted script is not valid based on the comparison of the converted script to the verification criteria, generating an additional prompt with instructions to re-engineer the converted script based on execution of a second AI model on the prompt and the converted script, and generating an updated converted script based on execution of the first AI model on the additional prompt and the script.

### BACKGROUND

An organization may spend years developing automation scripts for testing software such as applications, application programming interfaces (APIs), drivers, programs, services, firmware, and the like. As part of this process, the organization may rely on a test automation framework which includes a set of components that facilitate executing tests on a software and comprehensive reporting of test results. A test automation framework typically includes a combination of programs, compilers, features tools, and the like which can be used to execute automated test scripts. An automated test script is a set of instructions or code that are designed to automatically perform specific actions (e.g., test, etc.) upon a software program and verify the expected outcomes.

At present, there are different test automation frameworks, many of which cannot be integrated with one another. Therefore, a test automation script designed using a first test automation framework may not be executed by a second test automation framework without changing the source code. Therefore, when an organization needs to change test automation frameworks, they spend a significant amount of manual coding time to modify their existing test automation scripts to integrate with the new test automation framework, otherwise, the test automation scripts will no longer be usable.

### SUMMARY

One example embodiment provides an apparatus that includes a memory communicably coupled to a processor, wherein the memory may store verification criteria associated with at least one of a first automation framework and a second automation framework and the processor may one or more of iteratively convert a script associated with the first automation framework into a converted script associated with the second automation framework based on execution of a first artificial intelligence (AI) model on a prompt and the script, perform a comparison of the converted script to the verification criteria determine that the converted script is not valid based on the comparison of the converted script to the verification criteria, generate an additional prompt with instructions to re-engineer the converted script based on execution of a second AI model on the prompt and the converted script, and generate an updated converted script based on execution of the first AI model on the additional prompt and the script.

Another example embodiment provides a method that includes one or more of storing verification criteria associated with at least one of a first automation framework and a second automation framework in a memory device, converting a script associated with the first automation framework into a converted script associated with the second automation framework based on execution of a first artificial intelligence (AI) model on a prompt and the script, performing a comparison of the converted script to the verification criteria, determining that the converted script is not valid based on the comparison of the converted script to the verification criteria, generating an additional prompt with instructions to re-engineer the converted script based on execution of a second AI model on the prompt and the converted script, and generating an updated converted script based on execution of the first AI model on the additional prompt and the script.

A further example embodiment provides a computer readable storage medium comprising instructions, that when read by a processor, cause the processor to perform one or more of storing verification criteria associated with at least one of a first automation framework and a second automation framework in a memory device, converting a script associated with the first automation framework into a converted script associated with the second automation framework based on execution of a first artificial intelligence (AI) model on a prompt and the script, performing a comparison of the converted script to the verification criteria, determining that the converted script is not valid based on the comparison of the converted script to the verification criteria, generating an additional prompt with instructions to re-engineer the converted script based on execution of a second AI model on the prompt and the converted script, and generating an updated converted script based on execution of the first AI model on the additional prompt and the script.

### BRIEF DESCRIPTION OF DRAWINGS

FIG. 1 is a system diagram illustrating an operating environment of a software service according to examples and features of the instant solution.

FIG. 2A is a system diagram illustrating integration of an AI model into any decision point according to the examples and features of the instant solution.

FIG. 2B is a diagram illustrating a process for developing an AI model that supports AI-assisted computer decision points according to the examples and features of the instant solution.

FIG. 2C is a diagram illustrating a process for utilizing an AI model that supports AI-assisted computer decision points according to examples and features of the instant solution.

FIG. 3 is a diagram illustrating a process of calling an execution of an AI model according to examples and features of the instant solution.

FIG. 4A is a diagram illustrating a process of migrating an automation script from a first automation framework to a second automation framework according to examples and features of the instant solution.

FIG. 4B is a diagram illustrating a graphical user interface (GUI) associated with the migration process described in FIG. 4A, according to examples and features of the instant solution.

FIG. 5A is a diagram illustrating a process of splitting an automation script into a plurality of subsets of code according to examples and features of the instant solution.

FIG. 5B is a diagram illustrating a process of prompting an AI model to convert the plurality of subsets of code into converted code according to examples and features of the instant solution.

FIG. 5C is a diagram illustrating a sample prompt that may be input to the AI model in FIG. 5B, according to examples and features of the instant solution.

FIG. 6 is a diagram illustrating a process for controlling an automated end-to-end migration process from a first automation framework to a second automation framework according to examples and features of the instant solution.

FIG. 7A is a diagram illustrating a process of validating a converted automation script according to examples and features of the instant solution.

FIG. 7B is a diagram illustrating a GUI associated with the validating process described in FIG. 7A, according to examples and features of the instant solution.

FIGS. 8A-8C are diagrams illustrating an iterative optimization process for optimizing the converted automation script according to examples and features of the instant solution.

FIG. 9A is a diagram illustrating a method of migrating an automation script from a first automation framework to a second automation framework according to examples and features of the instant solution.

FIG. 9B is a diagram illustrating a method of iteratively optimizing a converted automation script according to examples and features of the instant solution.

FIG. 10 is a system diagram illustrating a computing environment according to the instant solution's example features, structures, or characteristics.

### DETAILED DESCRIPTION

The examples and features of the instant solution are directed to an automated migration process for migrating test automation scripts (e.g., also referred to as automation scripts, scripts, etc.) from a first automation framework to a second automation framework. In these examples, the first automation framework and the second automation framework are not compatible with one another. The differences between the frameworks may include different code structure, formatting, syntax, comments, statements, and the like, within the code being migrated. In particular, an artificial intelligence (AI) model (e.g., a generative AI model, etc.) can be used to convert the code associated with the first automation framework into at least one of a different format, a different style, different syntax, different content, different statements, different comments, and the like, to ensure that the code can be successfully executed by the second automation framework.

In some examples and features of the instant solution, the code being migrated is an automation test script such as those that are commonly used to perform automated tests on software programs such as software applications, application programming interfaces, and the like. Although not limited thereto, an example of the first automation framework is SOATEST® and the second automation framework is REST ASSURED®, however, examples of the instant solution are not limited thereto.

Organizations may spend years developing software tests and test automation scripts in a first automation framework for the purposes of executing the software tests on software programs (e.g., software applications, code, APIs, etc.) in an automated manner. The automation may also create reports with details/results about the tests performed. Often, developers may borrow code from older test automation scripts or at the very least, use the older test automation scripts as a guide to help design new test automation scripts. Over time, the organization may have thousands of test automation scripts that have been developed. When the organization desires to migrate their test automation scripts to a different framework that is not integrated with the first automation framework, the organization typically manually recodes the test automation scripts. Such an arduous task often prevents organizations from leaving the original test automation framework even when a different test automation framework may be better suited for testing their software.

In the examples and features of the instant solution, an automation script may be retrieved from a repository of the first automation framework, split into smaller subsets of code (e.g., files, etc.) and processed by an AI model to generate converted subsets of code that are associated with the second automation framework. For example, the conversion may cause the subsets of code to be executable by the second automation framework. To perform the conversion, the system may generate a prompt with instructions for the AI model to perform the conversion. The prompt may include instructions on what parts of the code to change, what parts of the code to keep, formatting instructions, comment instructions, command instructions, and the like. The converted subsets of code may be assembled into a converted automation script and stored in a repository of the second automation framework.

In some examples and features of the instant solution, the conversion process may be an iterative process that includes rounds of refinement to reach a predetermined threshold of accuracy. This threshold may be, at a minimum, the ability of the converted code to be successfully executed by the second automation framework. The system may include a validation component which can compare the converted code to different criteria, for example, formatting criteria of the second automation framework, business logic criteria of the original code, and coding standards of the organization, to ensure that the converted code adheres to each of the criteria. When the code fails to meet one or more of the criteria, the system may generate a new prompt based on execution of a second AI model, which may also be a generative AI model. The second AI model may use the original prompt, the original code, and the converted code, to generate a new prompt for re-engineering the converted code. This process may be iteratively repeated until the code satisfies all criteria.

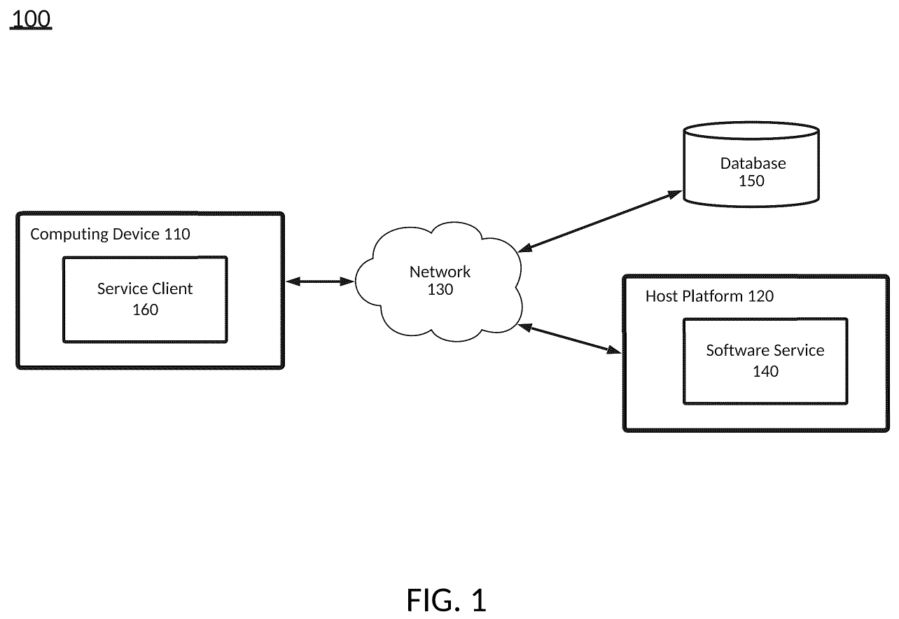

FIG. 1 is a system diagram illustrating an example operating environment of the instant solution. As shown, one or more computing devices 110, and a host platform 120 communicate via a network 130. The host platform 120 may host a software service 140. The software service 140 may communicate with one or more databases 150 through a network 130 during the course of service execution. Each computing device 110 may host a service client 160, which communicates with a corresponding software service 140.

A computing device 110 may be a mobile phone, tablet, laptop computer, desktop computer, or any computing device including a processor and memory. The host platform 120 may include a single physical server, multiple physical servers, a cloud hosting environment, or a hybrid hosting environment in which some components of the host platform 120 are “on-premise” while others are cloud-hosted. The network 130 is a computer network and may include one or more interconnected computer networks. For example, network 130 may be or may include an Ethernet network, an asynchronous transfer mode (ATM) network, a wireless network, a telecommunications network or the like.

The software service 140 provides the service logic. It may provide one or more Application Programming Interfaces (APIs) for communicating with one or more service clients 160. A “thick” user interface client that runs on a computing device 110 may utilize the APIs to communicate with the software service 140. Further, the software service 140 may provide hosted User Interfaces (UIs) that can be accessed through browser-based software on some computing devices 110.

The one or more service clients 160 can enable service access for end users and may come in a variety of forms including, but not limited to, a mobile device application (“app”) or a web portal accessed via a browser on a computing device 110 such as a laptop or desktop computer.

Detailed descriptions of the architecture and operation of the migration process between automation frameworks and the optimization of converted code in the instant solution are further described and depicted herein.

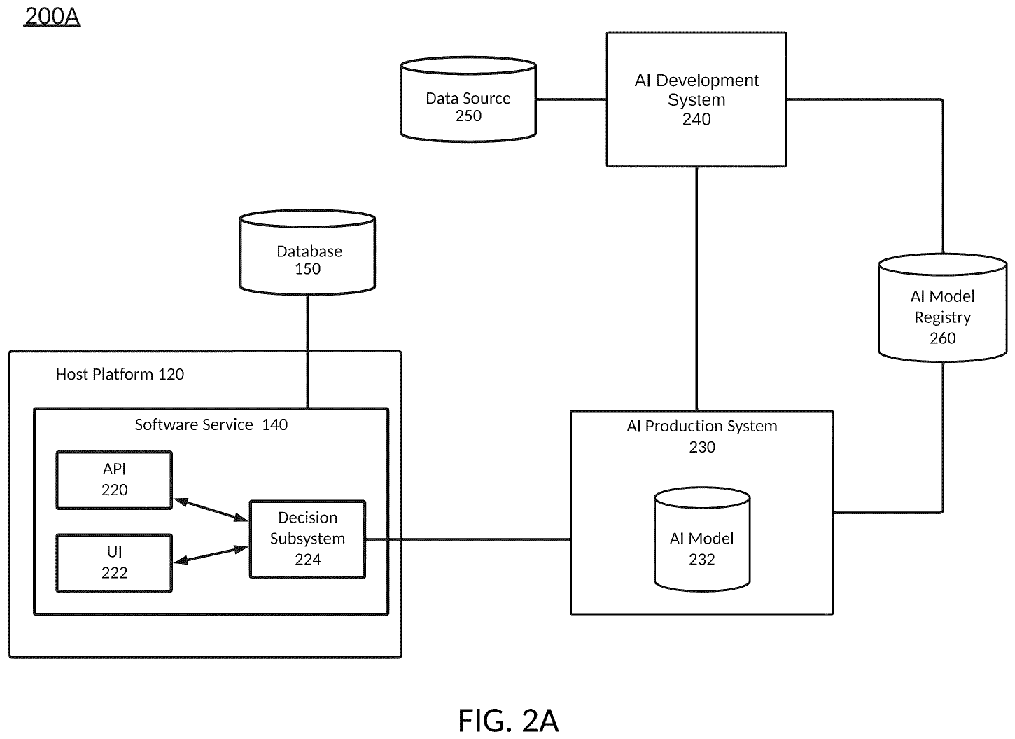

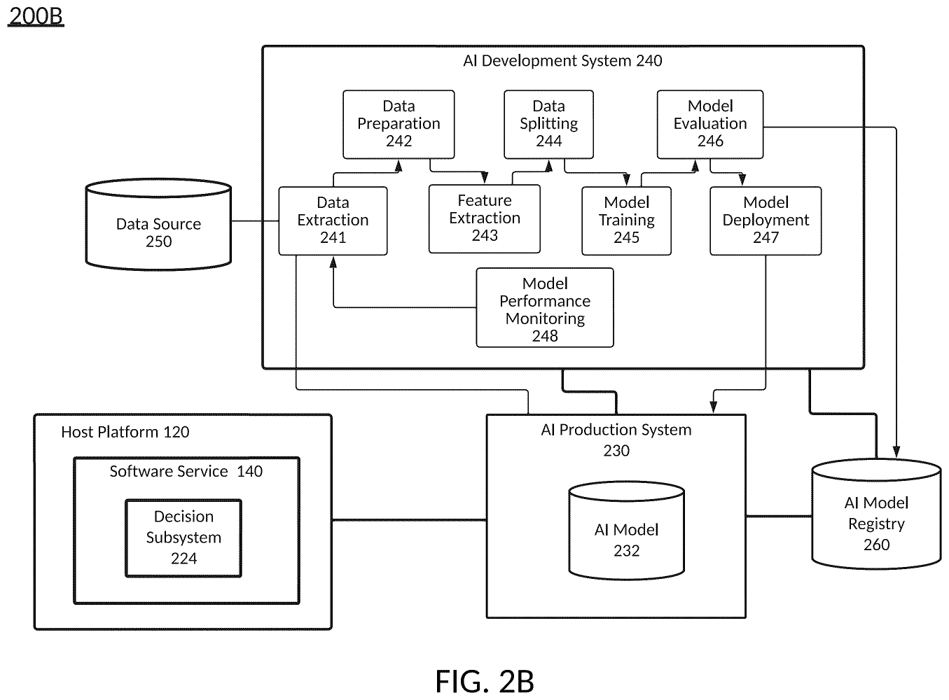

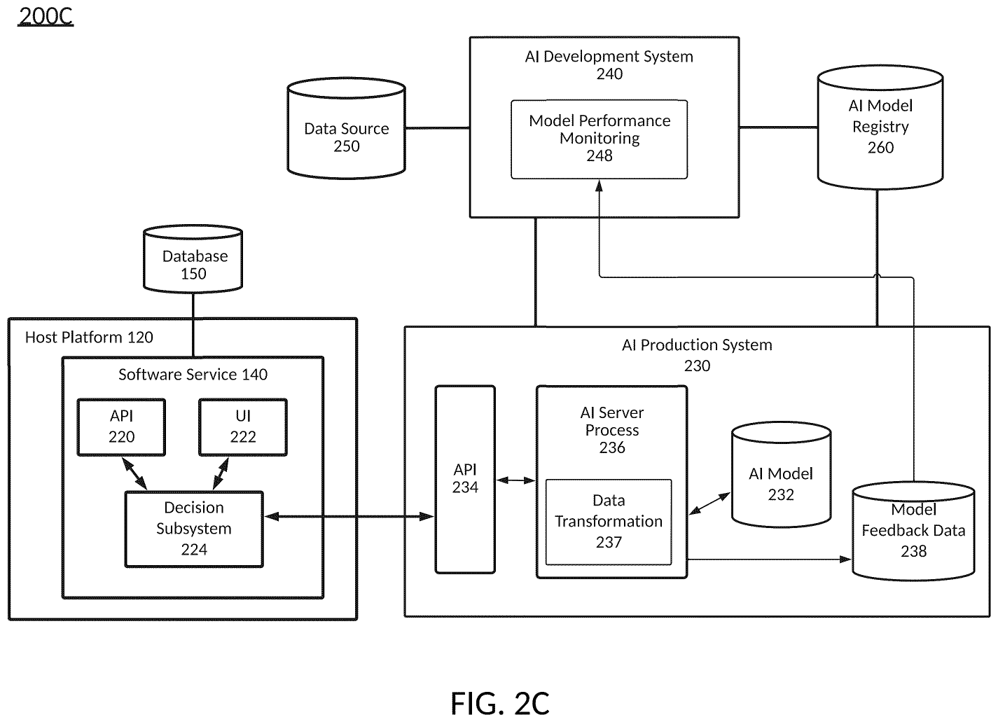

FIG. 2A illustrates an artificial intelligence (AI) network diagram 200A that supports AI-assisted decision points in a software service executing on a computer. While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, improving its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities relies on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI model refers to present-day AI models and future AI models.

Software service 140 (see FIGS. 1, 2A), executing on host platform 120 (see FIGS. 1, 2A) may provide one or more application programming interfaces (APIs) 220 that enable interaction with other software components via a set of data definitions and protocols. In some examples and features of the instant solution, the APIs provided may employ Simple Object Access Protocol (SOAP), Remote Procedure Calls (RPC), and Representational State Transfer (REST) techniques. In some examples and features of the instant solution, the plurality of APIs 220 send data to one or more decision subsystems 224 of the software service 140 to assist in decision-making. In some examples and features of the instant solution, the software service 140 stores data included in API requests or data generated during processing the API requests into one or more databases 150 (see FIGS. 1, 2A).

Software service 140 may provide one or more user interfaces (UIs) 222, such as a server-side hosted graphical user interface (GUI). In some examples and features of the instant solution, the UIs 222 provided employ template-based frameworks, component-based frameworks, etc. In some examples and features of the instant solution, these UIs 222 send data to one or more decision subsystems 224 of the software service 140 to assist with decision-making. In some examples and features of the instant solution, the software service 140 stores data included in UI requests or data generated during processing the UI requests into one or more databases 150.

Software service 140 may include one or more decision subsystems 224 that drive a decision-making process of the software service 140. In some examples and features of the instant solution, the decision subsystems 224 receive data from one or more APIs 220 as input into the decision-making process. In some examples and features of the instant solution, a decision subsystem 224 may receive data from one or more UIs 222 as input to the decision-making process. A decision subsystem 224 may gather service configuration or historical execution data from one or more databases 150 to aid in the decision-making process. A decision subsystem 224 may provide feedback to an API 220 or a UI 222.

An AI production system 230 may be used by a decision subsystem 224 in a software service 140 to assist in its decision-making process. The AI production system 230 includes one or more AI models 232 that are executed to generate a response, such as, but not limited to, a prediction, a categorization, a UI prompt, etc. In some examples and features of the instant solution, an AI production system 230 is hosted on a server. In some examples and features of the instant solution, the AI production system 230 is cloud-hosted. In some examples and features of the instant solution, the AI production system 230 is deployed in a distributed multi-node architecture.

An AI development system 240 creates one or more AI models 232. In some examples and features of the instant solution, the AI development system 240 utilizes data from one or more data sources 250 to develop and train one or more AI models 232. The data sources 250 may be local or third-party data sources. Further, the data provided by the data sources may be real-world or synthetic. In some examples and features of the instant solution, the AI development system 240 utilizes feedback data from one or more AI production systems 230 for new model development and/or existing model re-training. In some examples and features of the instant solution, the AI development system 240 resides and executes on a server. In some examples and features of the instant solution, the AI development system 240 is cloud hosted. In some examples and features of the instant solution, the AI development system 240 is deployed in a distributed multi-node architecture. In some examples and features of the instant solution, the AI development system 240 utilizes a distributed data pipeline/analytics engine.

Once an AI model 232 has been trained and validated in the AI development system 240, it may be stored in an AI model registry 260 for retrieval by either the AI development system 240 or by one or more AI production systems 230. The AI model registry 260 resides in a dedicated server in one example of the instant solution. In some examples and features of the instant solution, the AI model registry 260 is cloud-hosted. In some examples and features of the instant solution, the AI model registry 260 resides in the AI production system 230. In some examples and features of the instant solution, the AI model registry 260 is a distributed database.

FIG. 2B illustrates a process 200B for developing one or more AI models that support AI-assisted decision points. An AI development system 240 executes steps to develop an AI model 232 that begins with data extraction 241, in which data is loaded and ingested from one or more data sources 250. In some examples and features of the instant solution, historical model feedback data is extracted from one or more AI production systems 230.

Once the data has been extracted during data extraction 241, it undergoes data preparation 242 for model training. In some examples and features of the instant solution, this step involves statistical testing of the data to see how well it reflects real-world events, its distribution, the variety of data in the dataset, etc., and the results of this statistical testing may lead to one or more data transformations being employed to normalize one or more values in the dataset. In some examples and features of the instant solution, data deemed to be noisy is cleaned. A noisy dataset includes values that do not contribute to the training, such as, but not limited to, null and long string values. Data preparation 242 may be a manual process or an automated process using one or more of the elements and/or functions described and/or depicted herein.

Features of the data are identified and extracted during the feature extraction step 243. In some examples and features of the instant solution, a feature of the data is internal to the prepared data from the data preparation step 242. In some examples and features of the instant solution, a feature of the data requires a piece of prepared data from the data preparation step 242 to be enriched by data from another data source to be useful in developing the AI model 232. In some examples and features of the instant solution, identifying features may be a manual process or an automated process using one or more of the elements and/or functions described and/or depicted herein. Once the features have been identified, the values of the features are collected into a dataset that will be used to develop the AI model 232.

The dataset output from the feature extraction step 243 is split 244 into a training and validation data set. The training data set is used to train the AI model 232, and the validation data set is used to evaluate the performance of the AI model 232 on unseen data.

The AI model 232 is trained and tuned 245 using the training data set from the data splitting step 244. In this step, the training data set is provided to an AI algorithm and an initial set of algorithm parameters. The performance of the AI model 232 is then tested within the AI development system 240 utilizing the validation data set from step 244. These steps may be repeated with adjustments to one or more algorithm parameters until the model's performance is acceptable based on various goals and/or results.

The AI model 232 is evaluated 246 in a staging environment (not shown) that resembles the target AI production system 230. This evaluation uses a validation dataset to ensure the performance in an AI production system 230 matches or exceeds expectations. In some examples and features of the instant solution, the validation dataset from step 244 is used. In some examples and features of the instant solution, one or more unseen validation datasets are used. In some examples and features of the instant solution, the staging environment is part of the AI development system 240, and the staging environment is managed separately from the AI development system 240. Once the AI model 232 has been validated, it is stored in an AI model registry 260, where it can be retrieved for deployment and future updates. In some examples and features of the instant solution, the model evaluation step 246 may be a manual process or an automated process using one or more of the elements and/or functions described and/or depicted herein.

In some examples and features of the instant solution, the AI development system includes a user interface (not shown). The user interface may be used to manage the development system infrastructure, the steps 241-248 within the development system, the interim data transmitted between the various steps 241-248, and the data sources 250.

Once an AI model 232 has been validated and published to an AI model registry 260, it may be deployed during the model deployment step 247 to one or more AI production systems 230. In some examples and features of the instant solution, the performance of deployed AI model 232 is monitored 248 by the AI development system 240. In some examples and features of the instant solution, AI model 232 feedback data is provided by the AI production system 230 to enable model performance monitoring 248, and the AI development system 240 periodically requests feedback data for model performance monitoring 248, which includes one or more triggers that result in the AI model 232 being updated by repeating steps 241-248 with updated data from one or more data sources 250.

FIG. 2C illustrates a process 200C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 2C, an AI production system 230 may be used by a decision subsystem 224 in software service 140 to assist in its decision-making process. The AI production system 230 provides an API 234, executed by an AI server process 236 through which requests can be made. In some examples and features of the instant solution, a request may include an AI model 232 identifier to be executed based on the type of request. In some examples and features of the instant solution, a data payload (e.g., to be input to the AI model during execution) is included in the request. The data payload may include API 220 data from software service 140, UI 222 data from software service 140 or data from other software service 140 subsystems (not shown).

Upon receiving the API 234 request, the AI server process 236 may transform 237 the data payload or portions of the data payload to be valid feature values in an AI model 232. Data transformation 237 may include, but is not limited to, combining data values, normalizing data values, and enriching the incoming data with data from other data sources 250. Once the data transformation occurs, the AI server process 236 executes the appropriate AI model 232 using the transformed input data. Upon receiving the execution result, the AI server process 236 responds to the API requester, which is a decision subsystem 224 of software service 140. In some examples and features of the instant solution, the response may result in an update to a UI 222 in software service 140. In some examples and features of the instant solution, the response includes a request identifier that can be used later by the software service 140 to provide feedback on the performance of the AI model 232. In some examples and features of the instant solution, a model feedback record may be added into a model feedback data 238 by the AI server process 236.

In some examples and features of the instant solution, the API 234 includes an interface to provide AI model 232 feedback after an AI model 232 execution response has been processed. This mechanism enables the requester to provide feedback on the accuracy of the AI model 232 results. In some examples and features of the instant solution, the feedback interface includes the identifier of the initial request so that it can be used to associate the feedback with the request. Upon receiving a call into the feedback interface of the API 234, the AI server process 236 creates and adds a model feedback record into the model feedback data 238 which holds historical model feedback records. In some examples and features of the instant solution, the records in this model feedback data 238 are provided to model performance monitoring 248 in the AI development system 240. This model feedback data is streamed to the AI development system 240 or may be provided upon request. In some examples and features of the instant solution, the model feedback records in the model feedback data 238 are used as an input for retraining the AI model 232.

In some examples and features of the instant solution, the AI production system 230 includes a user interface (not shown). The user interface may be used to manage the production system infrastructure, the components of the production system 230-238, and the operation of the AI production system and its components.

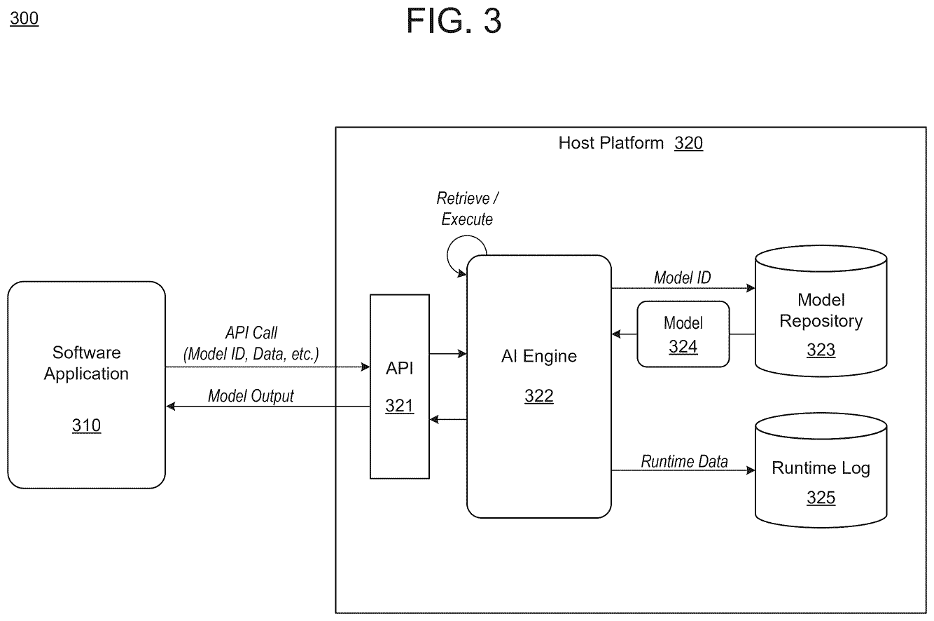

FIG. 3 illustrates a process 300 of executing a model 324 on input content according to examples and features of the instant solution. Referring to FIG. 3, software application 310 is an example of software service 140 (see, for example, FIGS. 1A, 2A-2C). Host platform 320 is an example of AI production system 230. API 321 is an example of API 234 of the AI production system 230 (see, for example, FIGS. 2A-2C). AI Engine 322 is an example of AI server process 236 of the AI production system 230 (see, for example, FIGS. 2A-2C). Model 324 is an example of AI model 232 deployed in the AI production system 230 (see, for example, FIGS. 2A-2C). Runtime log 325 is an example of model feedback data 238 of the AI production system 230 (see, for example, FIGS. 2A-2C). Model repository 323 is an example of AI model registry 260 (see, for example, FIGS. 2A-2C). As an example, the model 324 may be a generative AI model, however, examples and features of the instant solution are not limited thereto. Referring to FIG. 3, a software application 310 may request execution of the model 324 by submitting a request to the host platform 320 of the AI production system. For example, the request may include an API call or other submission identifiers of model data such as an identifier of the model to be executed, a payload of data to be input to the model during execution, an expected output, a storage location for the expected output, and the like. In response, an AI engine 322 may receive the request, retrieve the model 324 from a model repository 323, and trigger the model 324 to execute within a runtime environment of the host platform 320 of the AI production system.

In FIG. 3, the AI engine 322 may control access to models that are stored within the model repository 323. For example, the models may include AI models, generative AI models, machine learning models, neural networks, and/or the like. The software application 310 may trigger execution of the model 324 from the model repository 323 via invocation of a call to an API 321 of the AI engine 322. The request may include an identifier of the model 324 such as a unique ID assigned by the host platform 320, a payload of data (e.g., to be input to the model during execution), and the like. The AI engine 322 may retrieve the model 324 from the model repository 323 in response and deploy the model 324 within a live runtime environment of an AI production system. After the model is deployed, the AI engine 322 may execute the running instance of the model 324 on the payload of data and return a result of the execution to the software application 310.

In some examples and features of the instant solution, the payload of data may be a format that is not capable of being input to the model 324 nor read by a computer processor. For example, the payload of data may be in text format, image format, audio format, and the like, such as content from a web page or other format. In response, the AI engine 322 may convert the payload of data into a format that is readable by the model 324 such as a vector or other encoding. The vector may then be input to the model 324.

In some examples and features of the instant solution, the software application 310 may display a user interface which enables a user thereof to provide feedback from the output provided by the model 324. For example, a user may confirm that the output generated by the model 324 is relevant to the input. This information may be added to the results of execution and stored within a log 325. The log 325 may include an identifier of the input, an identifier of the output, an identifier of the model used, and feedback from the recipient. This information may be used to subsequently re-train the model by executing the model 324 on the input, the output, the model used, the feedback, and/or the like.

In the example of FIG. 3, one AI engine is shown, however, it should be appreciated that the host platform 320 of the AI production system may host multiple AI engines capable of training multiple models at the same time. For example, multiple AI engines may train multiple AI models to generate chatbot responses. Here the multiple AI models may be different, for example, different algorithms. As another example, the multiple AI models may be based on the same algorithm but trained using different training data. This results in multiple AI models capable of responding differently to the same query from a user.

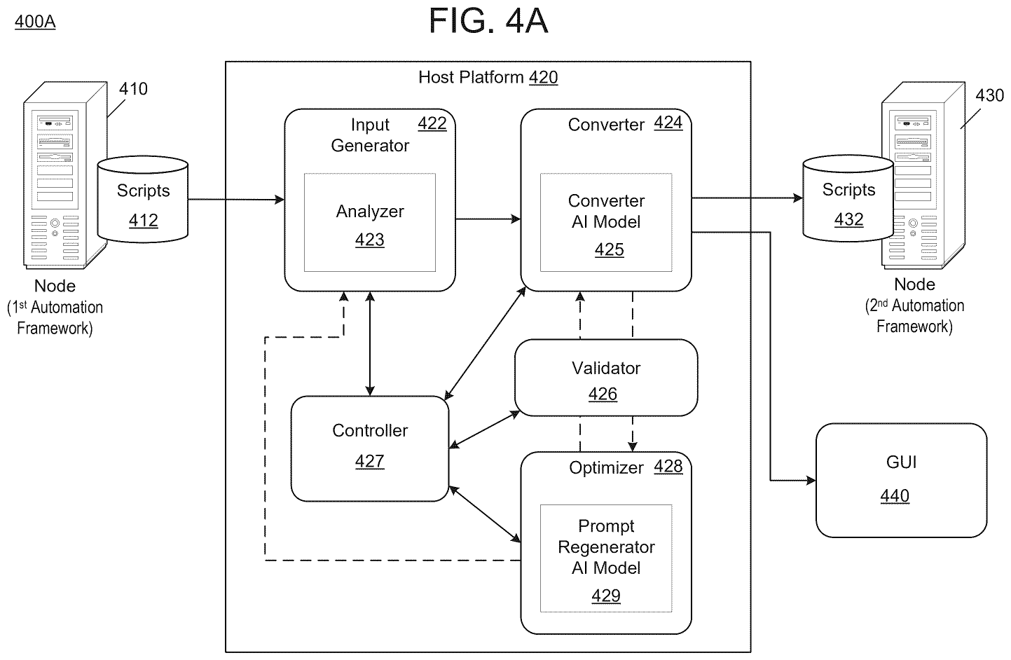

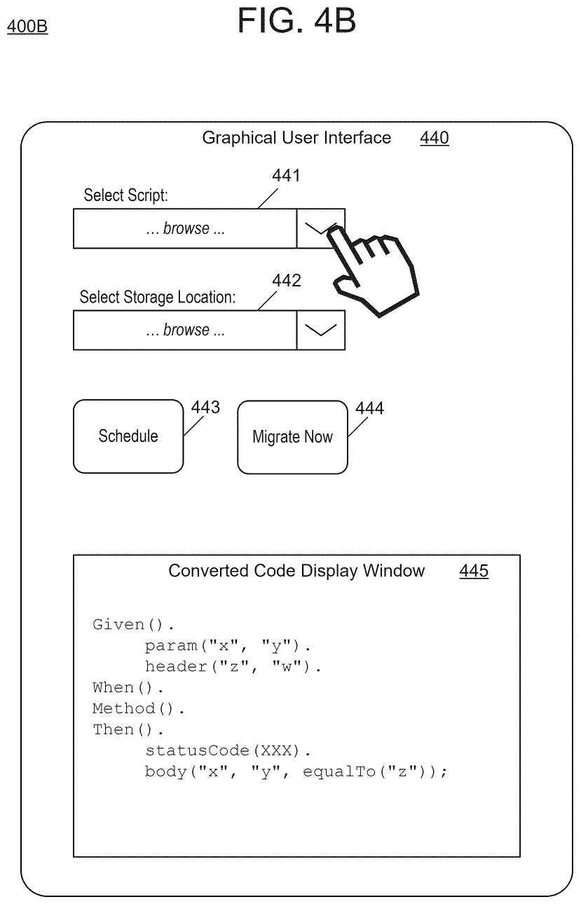

FIG. 4A illustrates a process 400A of migrating an automation script from a first automation framework to a second automation framework according to examples and features of the instant solution. Referring to FIG. 4A, host platform 420 is an example of a combination of host platform 120 and AI production system 230 (see, for example, FIGS. 2A-2C). Input generator 422, converter 424, validator 426, optimizer 428, and controller 427 are examples of software service 140 (see, for example, FIGS. 2A-2C). Converter AI model 425 and prompt regenerator AI model 429 are examples of AI model 232 of the AI production system 230 (see, for example, FIGS. 2A-2C). Scripts repositories 412 and 432 are examples of database 150 (see, for example, FIGS. 2A-2C). GUI 440 is an example of a user interface for a service client 160 on a computing device 110 (see, for example, FIG. 1).

Referring to FIG. 4A, a host platform 420 is in communication with a node 410 that stores scripts in a scripts repository 412 which are formatted, styled, structured, etc., in a first automation framework and a node 430 that stores scripts in a scripts repository 432 which are formatted, styled, structured, etc., in a second automation framework. In this example, the host platform 420 may be a cloud platform, a combination of systems, and the like. Meanwhile, the node 410 and the node 430 may be servers, software applications, services, computers, a combination thereof, and the like.

According to various examples and features of the instant solution, the host platform 420 may perform a migration process which migrates test automation scripts stored by the node 410, and executable by the first automation framework, to the node 430. As part of the migration process, the host platform 420 may automatically convert the test automation scripts into a form that is compatible/executable by the second automation framework. In the example of FIG. 4A, the end-to-end process may be automated through the use of a controller 427 of the host platform 420. For example, the controller 427 may include an executable script with instructions to retrieve automation scripts from the node 410 and trigger conversion of the automation scripts through the host platform 420. Furthermore, the executable script may include instructions for storing the converted automation scripts at the node 430.

According to various examples and features of the instant solution, an automation script may be retrieved from the scripts repository 412 of the node 410 through an invocation to an API (not shown) of the first automation framework and then input to an input generator 422. The input generator 422 may include an analyzer 423 component which analyzes the individual script and splits the automation script into a plurality of subsets of code. For example, the automation script may include a plurality of test files. Each test file may be parsed and turned into a different subset of code. The subsets of code may then be output by the input generator 422 and input to the converter 424. The converter 424 may include a converter AI model 425 that is configured to convert the subsets of code into converted subsets of code. In particular, the converter AI model 425 may convert the subsets of code (in a format of the first automation framework) into converted subsets of code (in a format of the second automation framework). Here, a prompt may be generated by the converter 424 with instructions for converting the subsets of code including formatting instructions, syntax instructions, logic instructions, style instructions, and the like.

In some examples and features of the instant solution, the converted subsets of code may be output by the converter 424, assembled into a converted automation script, and stored within the scripts repository 432 of the node 430 through an invocation to an API (not shown) associated with the second automation framework. In some examples and features of the instant solution, prior to storage in the scripts repository 432, the converted code may be validated. For example, a validator 426 may compare the converted subsets of code to various criteria including criteria associated with the second automation framework to ensure that the converted subsets of code can be successfully executed by the second automation framework. In addition, the validator 426 may compare the converted subsets of code to internal coding standards of an organization to ensure that the converted subsets of code adhere to the best practices of the organization. As another example, the validator 426 may compare the converted subsets of code to the original automation script retrieved from the node 410 to ensure the business logic/executable logic of the original automation script is still retained and not lost/missing.

When the validator 426 determines that the converted subsets of code fail to meet a threshold associated with one or more criteria, the validator 426 may output the converted subsets of code to an optimizer 428 which can generate a new prompt for re-engineering the converted subsets of code. The new prompt may be generated based on: the original subsets of code, the original prompt, and the converted subsets of code. Here, the new prompt may be generated by a prompt regenerator AI model 429, such as a generative AI model. The new prompt may be fed back to the input generator 422 and the process may be repeated. The process may be performed iteratively until the converted code achieves a threshold level of adherence to the criteria. When the converted code does achieve the threshold level of adherence, the converted code may be stored within the scripts repository 432 of the node 430 through an invocation to an API (not shown) associated with the second automation framework.

In some examples and features of the instant solution, GUI 440 may be running on a user device or computing device, such as a desktop computer, a laptop, a mobile device, or the like and is an example of a user interface for a service client 160 on a computing device 110 (see, for example, FIG. 1).

The process may be tracked via the GUI 440 which may be output to a user device. The GUI may be used to display notifications about the converted code, the results of the validation, the original prompt, the new prompt, and the like. Furthermore, the GUI 440 may include input controls which allow a user to input commands to control one or more parts of the end-to-end migration process.

FIG. 4B illustrates a view 400B of the GUI 440 associated with the migration process described in FIG. 4A, according to examples and features of the instant solution. Referring to FIG. 4B, the GUI 440 includes a first GUI input element 441 (e.g., a drop-down menu) for browsing and selecting a test automation script for migration from the scripts repository 412 of the node 410. The GUI 440 also includes a second GUI input element 442 for selecting a storge location of the converted automation script. Here, the storage location may be a storage location such as a file system, a folder, a directory, or the like, within the scripts repository 432 of the node 430 associated with the second automation framework.

In this example, the GUI 440 also includes an input button 443 which enables a user to schedule the migration process for the selected automation script at a future point in time. In addition, the GUI 440 also includes an input button 444 which enables the user to start the migration process, via the GUI 440. The GUI 440 also includes a display window 445 which can display the converted code content, and even allow the user to modify the converted code content.

In the examples of FIGS. 4A and 4B, the input generator 422, the converter 424, the validator 426, and the optimizer 428 may be code modules, services, software programs, and the like, capable of carrying out the functionality described herein.

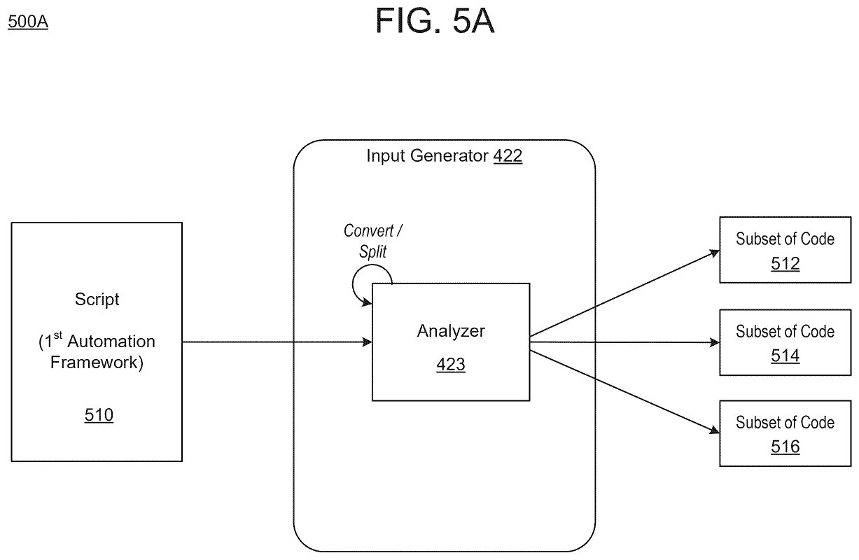

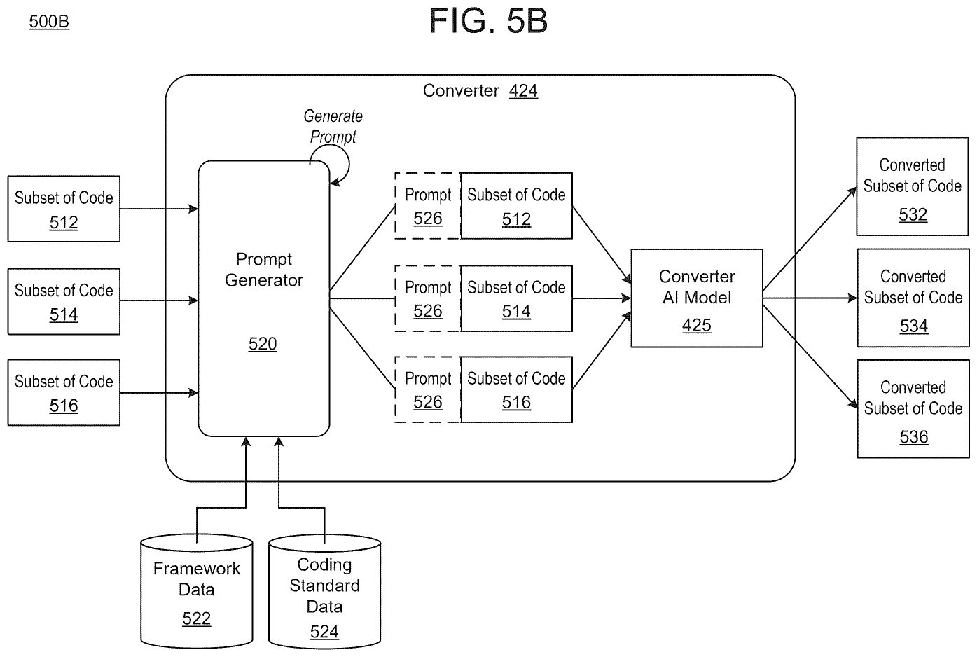

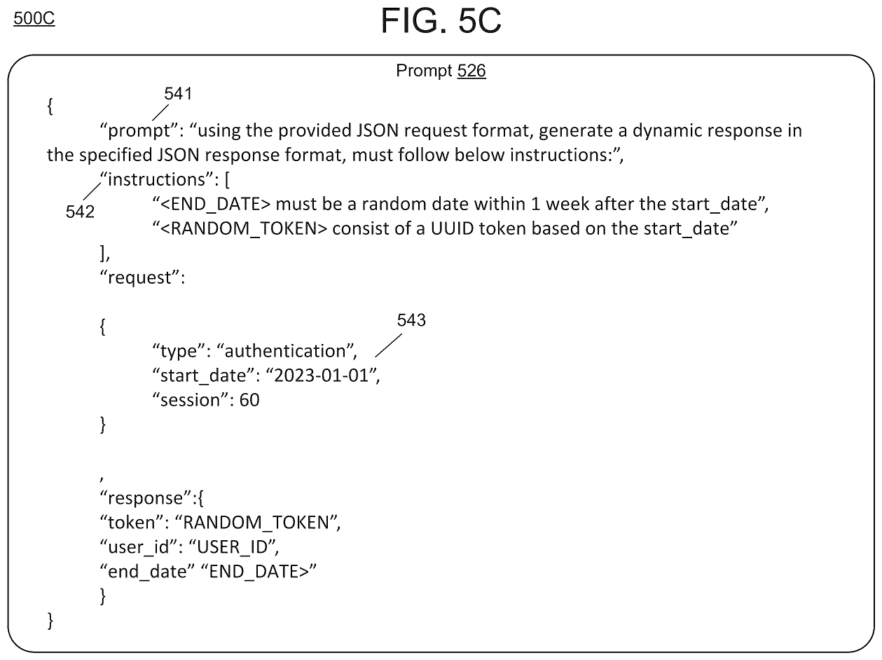

FIG. 5A illustrates a process 500A of splitting an automation script 510 into a plurality of subsets of code according to examples and features of the instant solution. Referring to FIG. 5A, input generator 422 is an example of software service 140 (see, for example, FIGS. 2A-2C) and may receive an identifier of a storage location from the controller 427 (shown in FIG. 4A) and retrieve an automation script 510 that is executable by the first automation framework from the scripts repository 412 via an invocation to an API (not shown) based on the received storage location. In this example, the automation script 510 may be in a native format of the first automation framework. Here, the input generator 422 may convert the automation script 510 into a different format such as extensible markup language (XML) or the like. As an example, the automation script 510 may originally be in a tab-separated table (TST) format that is then converted into XML format by the input generator. XML is independent of any automation framework thereby enabling the source code to be converted easily, rather than leaving the source code in its native format.

The automation script 510 may include a plurality of test files, where each test file corresponds to a different test case, test operation, test code, or the like. The analyzer 423 may parse the automation script 510 to identify the plurality of test files, and then split the automation script 510 into a plurality of subsets of code 512, 514, and 516 based on the plurality of test files (e.g., each subset may include a different test file, or more than one different test files, etc.). In some examples and features of the instant solution, the splitting may be performed based on a size of the files such that each of the subsets includes a similar or approximately the same size of code. In this example, the splitting process results in three subsets of code, however, examples and features of the instant solution are not limited thereto. The number of subsets may be determined by the number of files within the automation script 510. Therefore, there may be a different amount of subsets of code such as more than three subsets of code, or less than three subsets of code.

The converter AI model 425 (shown in FIG. 4A) may have restrictions on the size of input data that can be input to the converter AI model 425. By splitting the automation script into smaller parts (e.g., the plurality of subsets of code 512, 514, and 516) the input data becomes possible/easier to execute by the converter AI model 425. It also reduces the amount of time needed to execute the converter AI model 425 because there is fewer input data. Thus, the converter AI model 425 may be spawned into multiple instances which can be used to execute the plurality of subsets of code 512, 514, and 516, at the same time (simultaneously) to reduce the overall processing time.

FIG. 5B illustrates a process 500B of prompting the converter AI model 425 to convert the plurality of subsets of code 512, 514, and 516 into a plurality of converted subsets of code 532, 534, and 536, according to examples and features of the instant solution. Referring to FIG. 5B, framework data 522 and coding standard data are examples of database 150 (see, for example, FIGS. 2A-2C). Converter 424 is an example of software service 140 (see, for example, FIGS. 2A-2C). Converter AI model 425 is an example of AI model 232 of the AI production system 230 (see, for example, FIGS. 2A-2C).

Referring to FIG. 5B, the plurality of subsets of code 512, 514, and 516 generated by the input generator 422 shown in FIG. 5A may be input to the converter 424 shown in FIG. 5B. According to various examples and features of the instant solution, the converter 424 may include a prompt generator 520 that can generate a prompt which can be input to the converter AI model 425 with instructions for converting the plurality of subsets of code 512, 514, and 516, from a format that is executable by the first automation framework into a format that is executable by the second automation framework. Here, the prompt generator 520 may generate a prompt with instructions related to the formatting, the style, the business logic, and the like.

As an example, the prompt may include instructions which identify parts of the code to keep, parts of the code to change, how to change the code, and the like. FIG. 5C illustrates a view 500C of a prompt 526 that may be generated by the prompt generator 520 and input to the converter AI model 425, according to examples and features of the instant solution. It should be appreciated that the prompt 526 is merely an example and not meant to limit the scope of the examples and features of the instant solution. Here, the prompt 526 includes a task 541 to be performed, instructions 542, and logic 543. The task 541 may specify the output that the AI model is expected to generate from the input, input data that is to be modified, how the input data is to be modified, input data that is to be preserved, and the like. The instructions 542 may specify orders that are given to the AI model such as pieces of code to keep/retain, comments to keep, documentation to use, formatting to use, syntax to use, internal coding standards/styles to use, and the like. In some examples and features of the instant solution, the prompt generator 520 may use framework data 522 such as syntax, rules, formatting, documentation, and the like associated with one or more of the first automation framework and the second automation framework. As another example, the prompt generator 520 may use coding standards of an organization for generating the prompt 526, such as best practice guidelines, manuals, documents, etc.

Referring again to FIG. 5B, the prompt 526 may be added to a payload that includes the plurality of subsets of code 512, 514, and 516, and input to the converter AI model 425. Here, the input process may include generating an API call which includes the payload and submitting the API call to an API of the converter AI model 425 (or an AI engine of the AI model, etc.). Each subset of code from among the plurality of subsets of code 512, 514, and 516 may be converted to a plurality of converted subsets of code 532, 534, and 536, respectively. The converter AI model 425 may perform the conversion based on the prompt 526 and the respective code segment to generate a converted code segment.

Here, the converter AI model 425 may generate converted code (source code) that is executable by the second automation framework using the code that is previously executable by the first automation framework. The changes in formatting, comments, ordering of code, and the like, may ensure that the software can be executed by the different automation framework. In addition, the converter AI model 425 may also generate the converted code in a format that adheres to internal organizational standards.

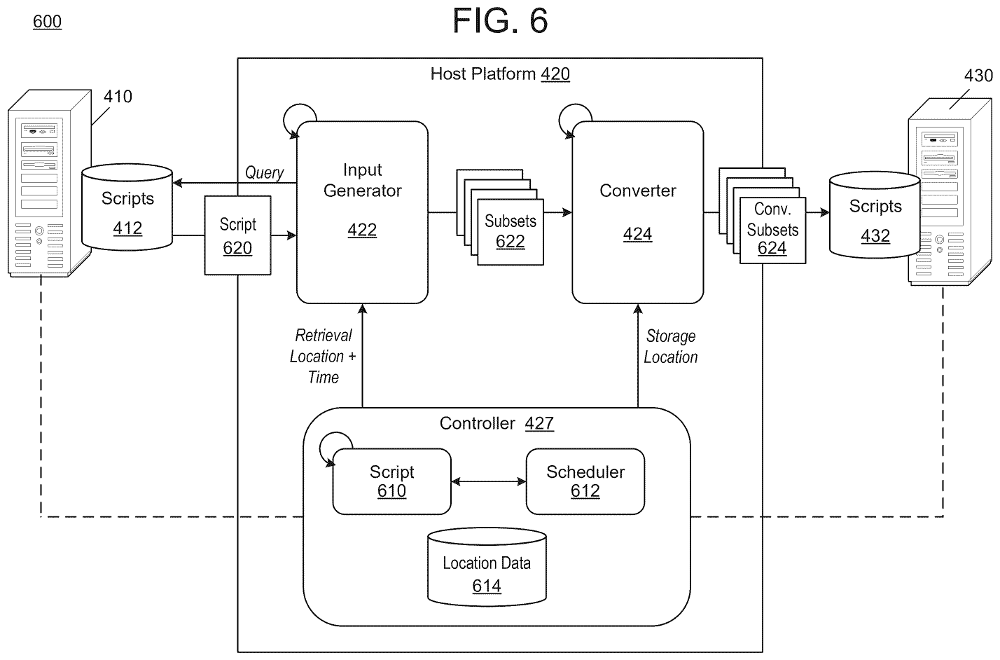

FIG. 6 illustrates a process 600 for controlling an automated end-to-end migration process from the node 410 of the first automation framework to the node 430 of the second automation framework according to examples and features of the instant solution. Referring to FIG. 6, the converted subsets 624 may be different than or may be the same as the converted subsets of code 532, 534, 536 described and depicted in FIG. 5B. Host platform 420 is an example of a combination of host platform 120 and AI production system 230 (see, for example, FIGS. 2A-2C). Input generator 422, converter 424, and controller 427 are examples of software service 140 (see, for example, FIGS. 2A-2C). Location data storage 614, scripts repositories 412 and 432 are examples of database 150 (see, for example, FIGS. 2A-2C).

Referring to FIG. 6, the controller 427 may include an executable script 610, a scheduler 612, and a location data storage 614 that tracks locations of automation scripts stored in the scripts repository 412 of the node 410 of the first automation framework and tracks locations of converted automation scripts stored in the scripts repository 432 of the node 430 of the second automation framework.

In this example, the executable script 610 may be triggered by a condition such as a timer reaching a point in time, an input from a graphical user interface, or some other condition. In response, the executable script 610 may read a list of automation scripts to be retrieved from the scripts repository 412 of the node 410 and migrated to the scripts repository 432 of the node 430. The list may be generated based on commands entered via a GUI. As another example, the list may be automatically populated based on a criteria entered via the GUI such as a storage location, a date of creation, a keyword name, or the like.

According to various examples and features of the instant solution, the executable script 610 may identify an automation script 620 to be migrated from the scripts repository 412 to the scripts repository 432 based on the scheduler 612. Here, the executable script 610 may identify a storage location of the automation script 620 within the scripts repository 412 based on locations that are stored within the location data storage 614. As an example, the location data storage 614 may include a file path where the automation script 620 can be located within the scripts repository 412. The file path may include a volume identifier, a directory identifier, one or more folder identifiers, and the like. Each identifier may be separated by a backslash or the like. For example, an automation script may be stored at a location (D: \DirectoryID\projectname\scriptname). That is, the identifiers may be identifiers of directories, names of folders, names of files, and the like. In response, the executable script 610 may identify a storage location of the automation script 620 within the scripts repository 412 from the location data storage 614 and trigger the input generator 422 to retrieve the automation script 620 from the scripts repository 412.

The executable script 610 may then trigger the analysis of the automation script 620 which causes the input generator 422 to split the automation script 620 into a plurality of subsets of code 622 which are then input to the converter 424. The splitting of the automation script 620 into smaller subsets may enable the converter AI model 425 to execute on the code therein (e.g., based on input data limitations, etc.). Also, the splitting of the automation script 620 may speed up the AI model execution process. Multiple instances of the converter AI model 425 may be deployed and used to execute the plurality of subsets of code 622 in parallel. The executable script 610 may invoke an API (not shown) on the converter 424 (which may include an AI execution engine not shown) which causes the converter 424 to execute the converter AI model 425 on the plurality of subsets of code 622. The API call may include a payload that includes the plurality of subsets of code 622 and a prompt generated by the prompt generator 520 (shown in FIG. 5B).

The converter 424 may convert the plurality of subsets of code 622 into a plurality of converted subsets of code 624 based on execution of the converter AI model 425 (shown in FIG. 4A) and the prompt. The converted subsets of code 624 may be assembled into a converted automation script and stored within the scripts repository 432 of the node 430. Here, the executable script 610 may determine where to store the converted automation script based on instructions provided by the scheduler 612, instructions input by a user via a graphical user interface, or the like. The storage location may include a file path within the scripts repository 432 of the node 430. The storage location may then be stored in the location data storage 614 along with an identifier/name of the automation script 620. This same process may be repeated for a plurality of automation scripts thereby alleviating a person from a need to be present or provide manual input to control the migration process.

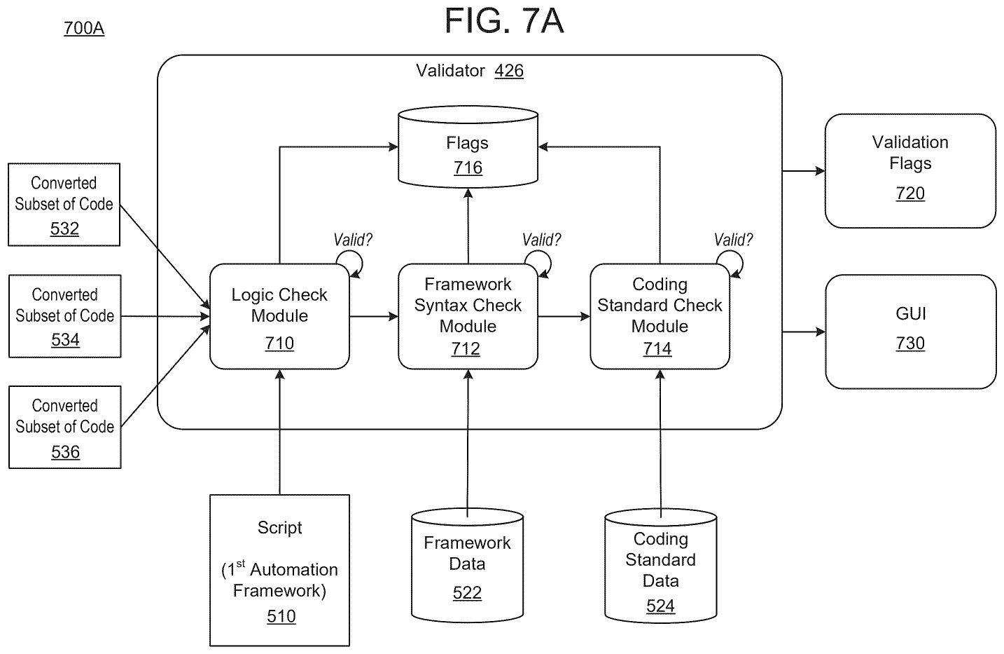

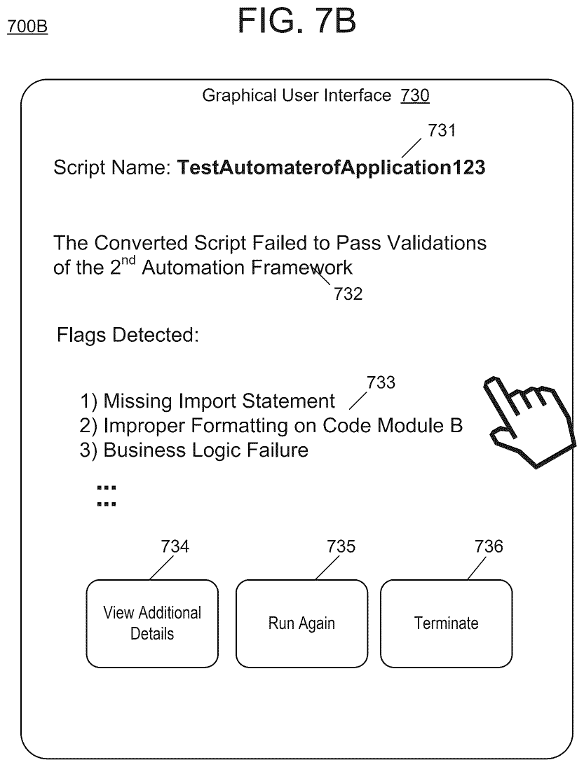

FIG. 7A illustrates a process 700A of validating a converted automation script according to examples and features of the instant solution. Referring to FIG. 7A, validator 426 is an example of software service 140 (see, for example, FIGS. 2A-2C). Framework data 522 and code standard data 524 are examples of database 150 (see, for example, FIGS. 2A-2C).

Referring to FIG. 7A, the plurality of converted subsets of code 532, 534, and 536, output by the converter 424 in FIG. 5B may be input to the validator 426 as shown in FIG. 7A. In this example, the validator 426 includes a plurality of verification modules including a logic check module 710, a framework syntax check module 712, and a coding standard check module 714. The plurality of converted subsets of code 532, 534, and 536 may be processed by each of the logic check module 710, the framework syntax check module 712, and the coding standard check module 714 to identify whether the plurality of converted subsets of code 532, 534, 536 satisfy a minimum threshold. Here, the threshold may be removal of potential errors.

For example, the logic check module 710 may compare the method, functions, operations, etc., within the plurality of converted subsets of code 532, 534, and 536 to the source code included in the automation script 510 originally parsed and split by the input generator 422 to ensure that the logic included in the automation script 510 is fully represented in the plurality of converted subsets of code 532, 534, and 536. If a method, step, code module, operation, variable, or the like, is missing from the plurality of converted subsets of code 532, 534, and 536, the logic check module 710 may determine that the plurality of converted subsets of code 532, 534, and 536 fail to satisfy the threshold. In response, the logic check module 710 may generate a flag (indicator) that is then stored in a flag storage 716 along with an identifier of the reason for the flag. However, if the plurality of converted subsets of code 532, 534, and 536 meet the logical requirements, the logic check module 710 may determine the threshold/criteria is met and not generate a flag.

Meanwhile, the framework syntax check module 712 may check the format of the syntax within the plurality of converted subsets of code 532, 534, and 536 to compare against the best standards required by the second automation framework, for example, the statements used (and whether required statements are present such as import statement, execute statement, declarations, etc.), the order of execution, comments, the variable types and names, and the like. The framework syntax check module 712 may pull data from the framework data 522 with best practices of the second automation framework. Here, the framework data 522 may include documents, manuals, code examples/files, and the like, which are stored within a data store. If the framework syntax check module 712 identifies any errors, the framework syntax check module 712 may determine that the plurality of converted subsets of code 532, 534, and 536 fail to satisfy the threshold. Furthermore, the framework syntax check module 712 may generate a flag that is then stored in the flag storage 716. However, if the plurality of converted subsets of code 532, 534, and 536 meet the framework syntax requirements, the framework syntax check module 712 may determine the threshold/criteria is met and not generate a flag.

Furthermore, the coding standard check module 714 may check the coding style within the plurality of converted subsets of code 532, 534, and 536 to ensure that they adhere to an organization's best practices. For example, the coding standard check module 714 may ingest documents, manuals, and the like, with organizational best practices from a coding standard data store 524 with manuals, documents, code samples, and the like of the organizational best practices and compare the best practices identified therein to the code within the plurality of converted subsets of code 532, 534, and 536. Here, the coding standard check module 714 may identify that variables and method names follow a particular naming convention, the names of variables and methods are shorter than a predetermined character length, predefined storage locations are used, comments are included and styled according to best practices, indention is styled according to best practices, version control checks, and the like. If the coding standard check module 714 identifies any errors, the coding standard check module 714 may determine that the plurality of converted subsets of code 532, 534, and 536 fail to satisfy the threshold. Furthermore, the coding standard check module 714 may generate a flag that is then stored in the flag storage 716. However, if the plurality of converted subsets of code 532, 534, and 536 meet the coding standard best practices, the coding standard check module 714 may determine the threshold/criteria is met and not generate a flag.

Here, the logic check module 710, the framework syntax check module 712, and the coding standard check module 714 may be executed in parallel on the plurality of converted subsets of code 532, 534, and 536 thereby ensuring the process is performed in parallel. As another example, the logic check module 710, the framework syntax check module 712, and the coding standard check module 714 may be executed in sequence thereby reducing a load on a system executing the validator 426. When each of the logic check module 710, the framework syntax check module 712, and the coding standard check module 714 are finished, the validator 426 may determine if any flags have been generated. For example, if any flags are generated, the validator 426 may determine that the validation threshold for the automation script has not been met (not satisfied). Here, any validation flags 720 may be output to the optimizer 428. However, if no flags are generated, the validator 426 may determine that the validation threshold has been met/satisfied and the plurality of converted subsets of code 532, 534, and 536, may be assembled into a converted automation script and stored in the script's repository 432.

The results of the criteria checking may be output to a graphical user interface (GUI) 730. GUI 730 may be running on a user device or computing device, such as a desktop computer, a laptop, a mobile device, or the like and is an example of a user interface for a service client 160 on a computing device 110 (see, for example, FIG. 1).

For example, FIG. 7B illustrates a view 700B of the GUI 730 associated with the validating process described in FIG. 7A, according to examples and features of the instant solution. Referring to FIG. 7B, the GUI 730 includes an identifier 731 of the automation script that is being migrated/converted, and a result 732 of the conversion of the automation script. The result 732 may be either successful/unsuccessful based on whether any validations failed. In addition, the GUI 730 may include identifiers 733 of any of the flags that were raised during the validation process. In addition, the GUI 730 may include a button 734 for viewing additional details of the migration process, a button 735 to run the conversion again, and a button 736 to terminate the process.

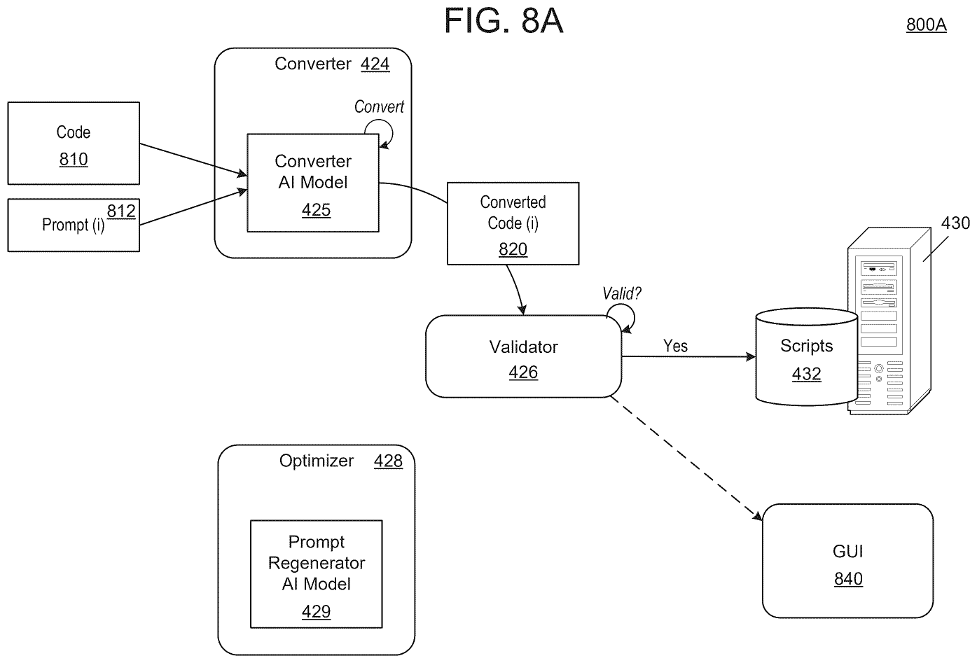

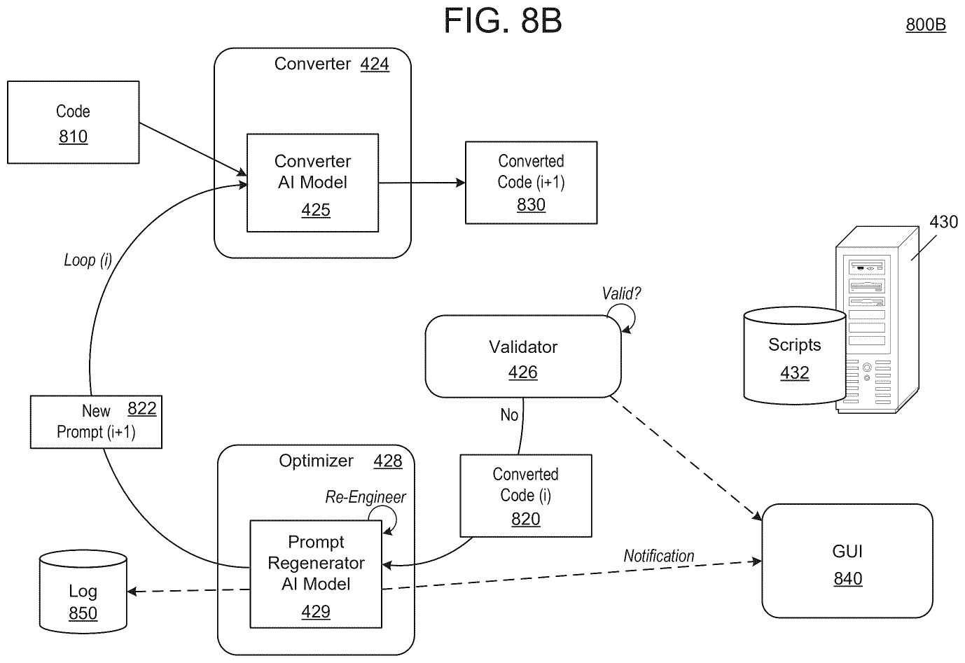

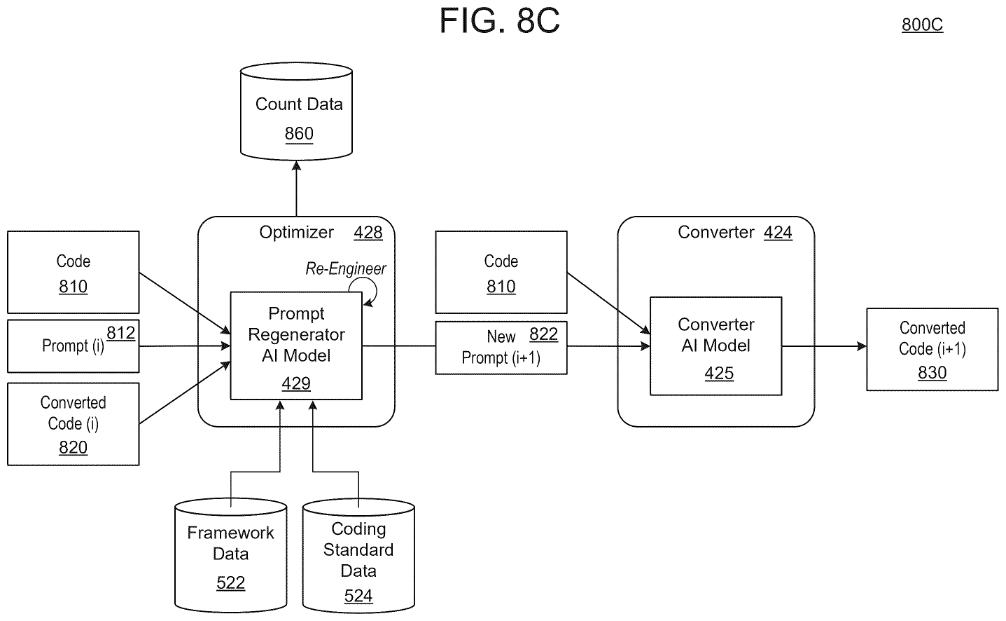

FIGS. 8A-8C are diagrams illustrating an iterative optimization process for optimizing the converted automation script according to examples and features of the instant solution. Referring to FIGS. 8A-8C, converter 424, validator 426, optimizer 428, and controller 427 are examples of software service 140 (see, for example, FIGS. 2A-2C). Converter AI model 425 and prompt regenerator AI model 429 are examples of AI model 232 of the AI production system 230 (see, for example, FIGS. 2A-2C). Log 850, count data 860, framework data 522, coding standard data 524, scripts repository 432 are examples of database 150 (see, for example, FIGS. 2A-2C). GUI 840 is an example of a user interface for a service client 160 on a computing device 110 (see, for example, FIG. 1).

According to various examples and features of the instant solution, the conversion performed by the host platform shown and described in the example of FIG. 4A may be performed on an iterative basis. For example, the validator 426 may be used to identify whether another round of conversion needs to be performed on the automation script being migrated from the node of the first automation framework to the node of the second automation framework. The decision may be based on whether the converted automation script fails to meet the validation threshold for any of the logic check, the automation framework syntax check, and the coding standard check.

For example, FIG. 8A illustrates a process 800A of generating a converted automation code 820 and determining whether or not to perform an additional iteration of the process based on the validator 426 according to examples and features of the instant solution. Referring to FIG. 8A, the converter 424 may receive a code 810 (such as an automation script, a test file parsed from an automation script, subset of code, etc.) which is written based on a first automation framework, and a prompt 812 such as a prompt from the prompt generator 520 described in FIG. 5A. Here, the converter AI model 425 may convert the code 810 into a converted code 820 based on the process described with respect to FIG. 5B.

Here, the converter AI model 425 may output the converted code 820 to the validator 426. In response, the validator 426 may perform one or more validations of the converted code 820, for example, logic checks, automation framework syntax checks, coding standard checks, and the like, to determine if the converted code 820 satisfies a verification threshold. For example, if the converted code 820 does not have any validation issues, the converted code 820 may be considered completed and may be stored within the scripts repository 432 of the node 430 associated with the second automation framework.

As another example, if any of the checks fail, the validator 426 may determine that the conversion process is to be repeated by the converter 424. For example, if any flags are generated by the process described in FIG. 7A, the validator 426 may trigger an additional iteration of the conversion. In the example of FIG. 8A, the validator 426 determines that at least one validation/check has failed (did not meet the validation threshold) and requests an additional iteration.

FIG. 8B illustrates a process 800B of performing an additional iteration/loop of the conversion process according to examples and features of the instant solution. Referring to FIG. 8B, the validator 426 determines that the converted code 820 is not valid because it did not pass one or more of the validation checks shown in the example of FIG. 7A. Here, the validator 426 may trigger the optimizer 428 to re-engineer a new prompt 822 to be used by the converter AI model 425 to generate an additional converted code 830. In this example, the validator 426 provides the optimizer 428 with the converted code 820 as an input. In response, the prompt regenerator AI model 429 generates the new prompt 822 based on execution on the converted code 820. The validator 426 may also output a notification to a GUI 840 with a status of the validation of the converted code 820 and an indication of whether a new iteration is being performed or whether the converted code is being stored. GUI 840 may be running on a user device or computing device, such as a desktop computer, a laptop, a mobile device, or the like and is an example of a user interface for a service client 160 on a computing device 110 (see, for example, FIG. 1).

According to various examples and features of the instant solution, the optimizer 428 may output the new prompt 822 and provide it to the converter 424. Here, the converter may execute the converter AI model 425 on the new prompt 822 and the code 810 (prior to the previous conversion). The new prompt may be re-engineered to provide a more accurate conversion of the code 810. Each time another iteration is performed through the loop, the optimizer 428 may update a count thereby tracking the number of iterations. If the count reaches a predetermined threshold (e.g., 5 iterations, 7 iterations, 10 iterations, etc.), the optimizer 428 may terminate the process and output a notification to a GUI 840. As another example, the optimizer 428 may log the termination (and details about how many iterations were performed, each new prompt generated, etc.) in a log 850.

FIG. 8C illustrates a process 800C of the prompt regenerator AI model 429 generating the new prompt 822 of FIG. 8B, according to examples and features of the instant solution. Referring to FIG. 8C, the optimizer 428 may receive the code 810 that is originally retrieved from the repository of the first automation framework, the prompt 812 generated by the prompt generator 520, and the converted code 820 output by the converter AI model 425, and input these to the prompt regenerator AI model 429. In some examples and features of the instant solution, the prompt regenerator AI model 429 may receive at least one of coding standard data of an organization from the coding standard data store 524 and framework syntax data from a framework data store 522. The framework syntax data may specify framework syntax requirement, constraints, etc. of the second automation framework. The prompt regenerator AI model 429 may generate the new prompt 822 based on these inputs.

In some examples and features of the instant solution, the prompt regenerator AI model 429 may be a custom-trained AI model that is trained to generate prompts based on a large corpus of input data such as prompts, automation framework syntax from different automation frameworks, coding standard data from an internal coding standard, and the like. As another example, the prompt regenerator AI model 429 may be a publicly available AI model that is uniquely configured by the different inputs shown in the example of FIG. 8C. The new prompt 822 output by the optimizer 428 may be input to the converter 424 along with the code 810 originally retrieved from the node of the first automation framework. In response, the converter AI model 425 may generate an additional converted code 830. This process may be iteratively repeated until the additional converted code meets the validation criteria/threshold.

In some examples and features of the instant solution, the instant solution comprises a memory configured to store an AI model and a processor configured to perform steps. The processor receives an automation script of a software test associated with a first automation framework. This script is typically stored in a repository associated with the first framework. The processor retrieves the script from this repository, which may be a file system, a database, or other suitable storage mechanism. The processor parses the automation script to identify a subset of code relevant to the software test. Parsing involves analyzing the script to extract specific code segments, such as test cases, operations, or functions that need to be migrated. This parsing process may include converting the script into a more manageable format, such as extensible markup language (XML) if it is not already in such a format. For example, the script might initially be in a tab-separated table (TST) format, which can be converted to XML to facilitate easier manipulation.

In some examples and features of the instant solution, the processor then generates a prompt with instructions for converting the automation script into a format associated with a second automation framework. This prompt comprises detailed instructions regarding the formatting, syntax, style, and specific transformations required to adapt the script from the first framework to the second framework. The rules, documentation, and best practices associated with both automation frameworks inform the prompt.

In some examples and features of the instant solution, using the AI model stored in memory, the processor converts the identified subset of code into a converted subset of code compatible with the second automation framework. The AI model processes the prompt and the subset of code to generate the converted code. The process ensures that the converted code retains the business logic and functionality of the original script while conforming to the requirements of the second framework. The AI model can handle various transformations, including changes in code structure, formatting, comments, and specific statements to ensure compatibility.

In some examples and features of the instant solution, once the conversion is complete, the processor creates a converted automation script based on the converted subset of code. This script is then displayed via a GUI, which provides a user-friendly way for users to review and interact with the converted script. The GUI may include a display window for viewing the converted code, input mechanisms for selecting scripts, and buttons for scheduling or initiating the migration process. The processor associates the converted automation script with the second automation framework. This involves storing the converted script in a repository associated with the second framework, configuring the second framework to recognize and execute the script, and ensuring that the script is readily accessible for future test automation processes.

In some examples and features of the instant solution, the instant solution is configured to parse the automation script into a plurality of subsets of code relevant to the software test. The input generator receives the automation script from the repository and may convert it into a format like extensible markup language (XML) if it is not already in such a format. This conversion is necessary because XML is independent of any specific automation framework, making it easier to process. The automation script, which may include multiple test files, is parsed and split into smaller subsets of code. Each subset can correspond to different test cases, operations, or other segments of the script. The splitting process can be based on the size of the files to ensure that each subset is manageable.

In some examples and features of the instant solution, the instant solution generates a prompt for each subset of code that includes instructions for converting the subset into a form associated with a second automation framework. The prompt generator creates detailed prompts that guide the AI model through the code transformation. These prompts include instructions related to formatting, style, business logic, and specific changes needed to adapt the code from the first framework to the second framework.

In some examples and features of the instant solution, using the AI model stored in memory, the instant solution converts each identified subset of code into a converted subset compatible with the second automation framework. The AI model processes the prompts and the subsets of code in multiple executions. Each subset is converted separately, ensuring that the converted code retains the business logic and functionality of the original script while conforming to the requirements of the second framework. The conversion process includes handling various transformations, such as changes in code structure, formatting, comments, and specific statements, to ensure compatibility. Once all subsets are converted, the instant solution assembles the converted subsets of code into a complete converted automation script. This script is then displayed via a GUI, which provides a user-friendly way for users to review and interact with the converted script. The GUI includes features such as a display window for viewing the converted code, input mechanisms for selecting scripts, and buttons for scheduling or initiating the migration process. The instant solution associates the converted automation script with the second automation framework. This involves storing the converted script in a repository associated with the second framework, configuring the second framework to recognize and execute the script, and ensuring that the script is readily accessible for future test automation processes.

In some examples and features of the instant solution, the instant solution is configured to receive an automation script of a software test associated with a first automation framework and parse the automation script to identify a subset of code relevant to the software test. Parsing involves analyzing the script to extract specific code segments, such as test cases, operations, or functions that need to be migrated. This parsing process may include converting the script into a more manageable format, such as extensible markup language (XML) if it is not already in such a format. For example, the script might originally be in a tab-separated table (TST) format, which can be converted to XML to facilitate easier manipulation. The instant solution then generates a prompt that includes instructions for converting the subset of the automation script into a form associated with a second automation framework. This prompt comprises detailed instructions regarding the formatting, syntax, style, and specific transformations required to adapt the script from the first framework to the second framework. The prompt is informed by the rules, documentation, and best practices associated with both automation frameworks.

In some examples and features of the instant solution, the instant solution invokes an application programming interface (API) call, which includes the prompt and the subset of code. The API call is used to transmit the prompt and the subset of code to an API of the AI model. Invoking an API call involves calling the execution of the AI model. Using the AI model, the instant solution converts the identified subset of code into a converted subset compatible with the second automation framework. The AI model processes the prompt and the subset of code to generate the converted code. This process ensures that the converted code retains the business logic and functionality of the original script while conforming to the requirements of the second framework. The AI model can handle various transformations, including changes in code structure, formatting, comments, and specific statements to ensure compatibility. Once the conversion is complete, the instant solution creates a converted automation script based on the converted subset of code. This script is then displayed via a GUI, which provides a user-friendly way for users to review and interact with the converted script. The GUI may include a display window for viewing the converted code, input mechanisms for selecting scripts, and buttons for scheduling or initiating the migration process. The instant solution associates the converted automation script with the second automation framework. This involves storing the converted script in a repository associated with the second framework, configuring the second framework to recognize and execute the script, and ensuring that the script is readily accessible for future test automation processes.

In some examples and features of the instant solution, the instant solution is configured to include instructions regarding comments, documentation, and formatting associated with the first automation framework into the prompt for converting an automation script. The instant solution receives an automation script associated with the first automation framework. This automation script typically includes elements such as comments, documentation, and specific formatting intrinsic to the first automation framework. The instant solution parses the automation script to identify a subset of code pertinent to the software test it is intended to execute. The instant solution generates a prompt with specific instructions for converting the automation script into a form compatible with a second automation framework. These instructions guide the AI model in converting the script while preserving the essential aspects of the original script, such as comments, documentation, and formatting. The comments within the script are retained to ensure that the context and purpose of different code segments are understood during and after the conversion process. Documentation associated with the first automation framework, which may include descriptions of test cases, expected outcomes, and other relevant information, is also incorporated into the prompt. This ensures the resulting converted script is comprehensive and retains the necessary information for effective execution and maintenance. The formatting instructions ensure that the structural integrity and readability of the code are maintained, adhering to the standards of the second automation framework.

In some examples and features of the instant solution, the instant solution is configured to access a schedule that specifies the timing for retrieving automation scripts from the first storage. The schedule can be managed and accessed in several ways. For example, the schedule may be stored in a database or a file system accessible to the instant solution. This storage may be local to the system or on a remote server accessible over a network. The schedule may be formatted as a calendar entry, a cron job, a table in a database, or any other suitable format that the processor can read and interpret. This format includes the specific times and dates for retrieving the automation scripts. The schedule can be configured based on various criteria, such as testing cycles, maintenance windows, or other operational considerations. The processor retrieves the automation script associated with the first automation framework from the first storage at the scheduled time. This storage can be a repository where scripts are stored in a native format specific to the first automation framework.

In some examples and features of the instant solution, once the automation script is retrieved, the instant solution begins parsing the script to identify subsets of code relevant to the software test it is intended to perform. These subsets may include individual test cases, operations, or other modular components of the script. The parsing process ensures that each script segment is correctly identified and prepared for conversion. The instant solution also generates a prompt with specific instructions for converting the identified subsets of code. These instructions are designed to facilitate the conversion of the script into a form that is compatible with the second automation framework. The prompt includes detailed guidelines on how the code is to be transformed, including changes in syntax, structure, and any framework-specific requirements. The AI model stored in memory is then executed by the processor using the generated prompt and the identified subsets of code. The AI model, trained to understand and convert scripts between different automation frameworks, processes the input data to generate converted subsets of code. These converted subsets adhere to the specifications and requirements of the second automation framework, ensuring compatibility and functionality.

In some examples and features of the instant solution, when the conversion is complete, the instant solution assembles the converted subsets into a cohesive converted automation script. This script is then stored in a second storage location associated with the second automation framework. The second storage can be a repository or database designated for scripts compatible with the second framework. The storing process involves organizing the script in a manner that is easily accessible and executable by the second automation framework. To complete the process, the instant solution configures the second automation framework to recognize and utilize the newly stored converted automation script. This configuration involves updating the framework's settings or pointers to ensure it can locate and execute the script within the second storage.

In some examples and features of the instant solution, the instant solution is configured to generate the prompt with instructions about a coding standard of a particular entity and convert the subset of code into the converted subset of code based on the coding standard of the specific entity. The instant solution generates a prompt that includes detailed instructions for converting the identified subsets of code. These instructions are specifically tailored to incorporate the coding standards of a particular entity. The coding standards may include guidelines on code formatting, naming conventions, commenting practices, and other best practices that the organization follows to maintain consistency and quality in its codebase. The coding standards are typically stored in a database, a configuration file, or a document accessible to the processor.

In some examples and features of the instant solution, the instant solution retrieves the coding standard data from its storage location to generate the prompt. This data is then integrated into the prompt, providing explicit instructions on how the code is to be transformed to adhere to the specified standards. For example, the prompt may include directives such as “convert variable names to camelCase,” “ensure all functions have header comments,” or “format code to comply with the style guide.” Once the prompt is generated, the AI model will guide the conversion process. The instant solution executes the AI model on the prompt and the parsed subsets of code. The AI model processes the input data, applying the instructions from the prompt to transform the code. This involves making changes to the syntax, structure, and other aspects of the code to ensure it aligns with the coding standards of the particular entity. During conversion, the AI model may modify variable names, adjust code indentation, add or update comments, and reformat the code according to the provided guidelines. The resulting output is a converted subset of code that is compatible with the second automation framework and adheres to the organization's coding standards.

In some examples and features of the instant solution, the instant solution is configured to receive a command submitted via a GUI, parse the automation script, and generate the prompt in response to the command submitted via the GUI. The instant solution includes a GUI, which serves as an interface for users to interact with the system. The GUI is displayed on user devices such as desktop computers, laptops, or mobile devices and provides various controls and input mechanisms. Users can submit commands via the GUI to initiate different processes, including converting automation scripts. When a user submits a command through the GUI to convert an automation script, the instant solution receives this command. The command may include selecting a specific script from a list, specifying parameters for the conversion, or setting preferences for the output.

In some examples and features of the instant solution, upon receiving the command, the instant solution initiates the parsing of the selected automation script. The script, which is associated with a first automation framework, is retrieved from its storage location. The instant solution then parses the script to identify subsets of code relevant to the software test it is intended to perform. These subsets can include individual test cases, methods, or other segments of the script. The instant solution generates a prompt that includes detailed instructions for converting the identified subsets of code. The prompt may specify guidelines for transforming the code into a format compatible with a second automation framework. These instructions might involve changes to syntax, structure, comments, and other code elements to ensure compatibility and adherence to any specified coding standards.

In some examples and features of the instant solution, the generated prompt is used by the AI model to guide the conversion process. The instant solution executes the AI model on the prompt and the parsed subsets of code. The AI model processes the input data, applying the instructions from the prompt to transform the code as required. This transformation ensures that the code is not only compatible with the second automation framework but also meets any additional requirements specified by the user via the GUI. The converted subsets of code are then assembled by the instant solution into a cohesive converted automation script. This script is displayed via the GUI, providing the user with an opportunity to review and interact with the converted code. The GUI may include features such as syntax highlighting, code comparison, and editing capabilities to facilitate the review process. The instant solution associates the converted automation script with the second automation framework. This involves storing the converted script in a designated repository that is accessible by the second framework. The repository configuration ensures that the script can be executed as part of the organization's automated testing processes.

In some examples and features of the instant solution, the instant solution is configured to export the automation script of a software test associated with the first automation framework from the first automation framework in a native programming language and convert the automation script from the native programming language into an extensible markup language (XML) prior to parsing the automation script. The instant solution retrieves the automation script associated with the first automation framework from its storage location. The script is initially in the native programming language of the first automation framework, which may be a proprietary format or a commonly used scripting language specific to that framework. Once the automation script is retrieved, the instant solution initiates the export process. This involves extracting the script from the first automation framework in its native format. The export process may involve accessing the framework's APIs, file system, or other interfaces to obtain the script. The native programming language might include framework-specific commands, structures, and comments that need to be preserved during the conversion.

In some examples and features of the instant solution, after exporting the automation script in its native programming language, the instant solution converts the script into an extensible markup language (XML) format. XML is chosen for its flexibility and compatibility with various processing tools. Converting the script to XML involves transforming the native code into XML tags and elements that represent the structure and content of the original script. This process includes translating code segments, comments, and metadata into an XML format while preserving the logical flow and details of the original script. The conversion to XML facilitates easier manipulation and parsing of the script by standardizing the format. XML provides a structured and hierarchical representation of the script, making it easier for the AI model and other processing tools to interpret and transform the code.

In some examples and features of the instant solution, once the script is in XML format, the instant solution proceeds to parse the XML document. Parsing the XML involves reading the document and identifying the various elements and attributes that correspond to different parts of the automation script. The parsing process extracts subsets of code, which can include individual test cases, methods, or other relevant segments of the script. The instant solution then generates a prompt that includes detailed instructions for converting the identified subsets of code. These instructions guide the AI model in transforming the code from the XML format into a form compatible with the second automation framework. The prompt may specify changes in syntax, structure, and other elements to ensure compatibility with the new framework. The generated prompt is then used by the AI model to perform the conversion. The processor executes the AI model on the prompt and the parsed subsets of code, applying the instructions to transform the code as required. This transformation ensures that the code is compatible with the second automation framework while maintaining the logical structure and functionality of the original script. The converted subsets of code are then assembled by the instant solution into a cohesive converted automation script. This script is stored in a designated repository associated with the second automation framework, making it accessible for execution within the new framework.

In some examples and features of the instant solution, the instant solution configures an apparatus for converting test automation scripts from a first automation framework to a second automation framework using artificial intelligence (AI). The apparatus comprises a memory configured to store verification criteria associated with at least one of the first and second automation frameworks and a processor configured to iteratively convert a script from the first automation framework to the second automation framework. The instant solution executes the first AI model on a prompt. The script compares the converted script to the verification criteria. If the converted script is not valid based on the comparison, the instant solution generates an additional prompt with instructions to re-engineer the converted script based on executing a second AI model on the prompt and the converted script. Subsequently, the instant solution generates an updated converted script based on executing the first AI model on the additional prompt and the script. The memory stores verification criteria, including predetermined formatting criteria, coding standards, and logical consistency checks for the first and second automation frameworks. This ensures that the converted script adheres to the second automation framework's necessary standards and maintains the original script's logical integrity.

In some examples and features of the instant solution, the instant solution receives a script associated with the first automation framework and parses it to identify subsets of code. It generates a prompt with instructions for converting the script into a form compatible with the second automation framework. This prompt guides the first AI model in converting the script. The converted script is then compared against the stored verification criteria. The comparison involves checking the script's formatting against the standards of the second automation framework, ensuring adherence to the coding standards of the associated entity, and verifying logical consistency with the original script. If the converted script does not meet the verification criteria, the instant solution flags the errors and may display these results via the GUI, providing a detailed comparison result. The instant solution then generates an additional prompt using the second AI model, incorporating feedback and error details to refine the conversion process. This additional prompt is used by the first AI model to reprocess the original script, generating an updated converted script.

In one example, the displayed result may be analyzed by at least one of the processors or nodes described or depicted herein and approved by such a processor or node. In another example, the comparison may be approved by an individual.

In some examples and features of the instant solution, the iterative process involves multiple rounds of conversion and verification until the converted script meets all criteria or a predetermined iteration threshold is reached. The instant solution tracks the number of iterations performed, ensuring that the process terminates after a certain number of attempts if the script cannot be validated. Upon reaching the iteration threshold, the instant solution logs the process details and notifies the user via the GUI, indicating the termination of the conversion process.

In some examples and features of the instant solution, the instant solution compares the converted script based on predetermined formatting criteria of the second automation framework and determines that the converted script is not valid if it does not meet these criteria. The formatting criteria may include specific requirements for the structure, syntax, and style of the code as mandated by the second automation framework. The memory stores these predetermined formatting criteria, including rules regarding indentation, line spacing, code blocks, comment styles, import statements, variable declarations, and other syntactical elements. These criteria ensure that the converted script is formatted in a way consistent with the expectations and standards of the second automation framework.

In some examples and features of the instant solution, upon receiving the script associated with the first automation framework, the instant solution parses it to identify subsets of code. It then generates a prompt with detailed instructions for converting the script into the required format of the second automation framework. This prompt guides the first AI model in performing the conversion. The converted script is then compared rigorously against the stored formatting criteria. This involves checking each script element to ensure it conforms to the required syntax and style. For example, the framework syntax check module may verify necessary statements such as import declarations, execution statements, and the correct order of operations per the second framework's standards. It also ensures that comments are correctly formatted and that the code adheres to the required indentation and line spacing rules. If any discrepancies are found, such as incorrect indentation, missing statements, or improperly formatted comments, the instant solution flags these errors. The GUI displays these formatting issues, providing a detailed account of where the converted script deviates from the required formatting criteria.

In some examples and features of the instant solution, to address these issues, the instant solution generates an additional prompt using the second AI model. This new prompt incorporates feedback from the formatting comparison, providing specific instructions to correct the identified errors. The first AI model then uses this additional prompt to reprocess the original script, generating an updated converted script that better adheres to the formatting criteria. This iterative process continues until the converted script meets all the formatting criteria of the second automation framework or a predetermined iteration threshold is reached.

In some examples and features of the instant solution, the instant solution performs the comparison of the converted script based on a coding standard of an entity associated with the second automation framework and determines that the converted script is not valid if it does not meet these coding standards. The coding standards may include rules and guidelines specific to the entity, such as naming conventions, code structure, comment styles, and other best practices that ensure the code is maintainable, readable, and consistent with the entity's development guidelines. The memory stores these coding standards, which can encompass a wide range of criteria such as variable naming conventions, method naming conventions, code modularization practices, comment formatting, and overall code organization principles. These standards are vital for maintaining consistency and quality across all scripts within the entity.

In some examples and features of the instant solution, upon receiving the script associated with the first automation framework, the instant solution parses it to identify subsets of code. It then generates a prompt that includes detailed instructions for converting the script into the required form that adheres to the coding standards of the second automation framework. This prompt guides the first AI model in performing the conversion. The converted script is then thoroughly compared against the stored coding standards. This involves checking each element of the script to ensure it adheres to the prescribed naming conventions, structuring practices, and comment styles. For example, the coding standard check module may verify that variable names follow a specific naming pattern, methods are named according to function, comments are clear and follow a standard format, and the overall code structure is modular and organized. If any discrepancies are found, such as improperly named variables, poorly formatted comments, or non-modular code structure, the processor flags these errors. The GUI displays these issues, providing a detailed account of where the converted script deviates from the coding standards.

In some examples and features of the instant solution, to address these issues, the instant solution generates an additional prompt using the second AI model. This new prompt incorporates feedback from the comparison, providing specific instructions to correct the identified coding standard violations. The first AI model then uses this additional prompt to reprocess the original script, generating an updated converted script that better adheres to the coding standards. This iterative process continues until the converted script meets all the coding standards of the second automation framework or a predetermined iteration threshold is reached.

In some examples and features of the instant solution, the instant solution performs the comparison of the converted script based on the logic included in the script associated with the first automation framework and determines that the converted script is not valid if it does not maintain the original logic. The logic verification ensures that the functionality of the script remains consistent during the conversion process, meaning that the automated tests defined in the original script perform the same actions and checks in the converted script. The memory stores these logic verification criteria, which include specific methods, operations, sequences of actions, and expected outcomes as defined in the original script. This ensures that the logical flow, data manipulations, and test validations present in the original script are preserved in the converted script.

In some examples and features of the instant solution, upon receiving the script associated with the first automation framework, the instant solution parses it to identify subsets of code and their corresponding logical components. It then generates a prompt with detailed instructions for converting the script into a form that preserves the original logic within the second automation framework. This prompt guides the first AI model in performing the conversion. The converted script is then compared rigorously against the stored logic verification criteria. This involves checking each logical component of the script to ensure it adheres to the original methods, operations, and sequences. For example, the logic check module may verify that specific test steps, assertions, data manipulations, and flow controls in the original script are correctly translated into the converted script. If any discrepancies are found, such as missing test steps, altered data manipulations, or incorrect flow controls, the instant solution flags these errors. The GUI displays these logical issues, providing a detailed account of where the converted script deviates from the original logic.

In some examples and features of the instant solution, to address these issues, the instant solution generates an additional prompt using the second AI model. This new prompt incorporates feedback from the logic comparison, providing specific instructions to correct the identified logical errors. The first AI model then uses this additional prompt to reprocess the original script, generating an updated converted script that better preserves the original logic. This iterative process continues until the converted script meets all the logical criteria of the original script or a predetermined iteration threshold is reached.

In some examples and features of the instant solution, the instant solution is configured to track the number of iterations performed during the conversion process and, in response to the number of iterations being below a predetermined threshold, continue to generate the updated converted script. This ensures that the conversion process can be repeated multiple times to refine the script until it meets the necessary criteria while preventing an infinite loop of iterations. The memory stores the verification criteria, which include predetermined formatting criteria, coding standards, and logical consistency checks for both the first and second automation frameworks. These criteria are used to validate the converted script at each iteration. Additionally, the memory also stores the count of iterations performed, which the processor accesses to determine if further iterations are permissible.

In some examples and features of the instant solution, upon receiving the script associated with the first automation framework, the instant solution parses it to identify subsets of code. It generates a prompt that includes detailed instructions for converting the script into the required form of the second automation framework. This prompt guides the first AI model in performing the conversion. After converting the script, the instant solution performs a rigorous comparison against the stored verification criteria. This involves checking the formatting, coding standards, and logical integrity of the converted script. If any discrepancies are found, the processor flags these errors and displays them via the GUI. If the converted script does not meet the verification criteria, the instant solution increments the iteration count and checks if the number of iterations is below the predetermined threshold. If the count is below the threshold, the instant solution generates an additional prompt using the second AI model, incorporating feedback from the comparison and reprocessing the original script to generate an updated converted script. This iterative process ensures continuous script improvement through multiple rounds of conversion and validation. Each iteration aims to refine the script, addressing any identified issues to ensure compliance with the second automation framework's criteria. The instant solution keeps track of the iteration count. As long as the count remains below the threshold, it continues the iterative process to enhance the accuracy and quality of the converted script.

In some examples and features of the instant solution, the instant solution is configured to track the number of iterations performed during the conversion process. In response to the number of iterations reaching a predetermined threshold, the instant solution terminates the execution of the first AI model and the second AI model and logs a notification or displays the notification via the GUI. This mechanism ensures that the conversion process does not continue indefinitely and provides a practical stopping point if the script cannot be validated within a reasonable number of iterations. The memory stores the verification criteria, including predetermined formatting criteria, coding standards, logical consistency checks for both the first and second automation frameworks, iteration count, and threshold value. These criteria are used to validate the converted script at each iteration. The threshold value determines the maximum number of iterations allowed before the process is terminated.

In some examples and features of the instant solution, upon receiving the script associated with the first automation framework, the instant solution parses it to identify subsets of code. It generates a prompt that includes detailed instructions for converting the script into the required form of the second automation framework. This prompt guides the first AI model in performing the conversion. After converting the script, the instant solution compares thoroughly against the stored verification criteria, checking for formatting, coding standards, and logical integrity. If discrepancies are found, the processor flags these errors and displays them via the GUI. If the converted script does not meet the verification criteria, the instant solution increments the iteration count and checks if the number of iterations has reached the predetermined threshold. If the threshold is reached, the instant solution terminates the execution of both the first and second AI models. It logs a notification or displays it via the GUI, indicating that the maximum number of iterations has been reached and the conversion process is being terminated. This ensures that the conversion process does not become an endless loop, providing a practical limit to the number of iterations. It also ensures that users are informed when the process cannot successfully convert the script within the set number of attempts.

In some examples and features of the instant solution, the instant solution is configured to generate the additional prompt with instructions to re-engineer the converted script based on the execution of the second AI model on one or more documents that define a coding standard of an entity associated with the second automation framework. This ensures that the converted script not only adheres to the general formatting and logical criteria but also complies with the specific coding standards and practices of the entity utilizing the second automation framework. The memory stores these coding standards, including detailed guidelines, best practices, naming conventions, and structural requirements unique to the entity. These standards are typically documented in various formats, such as manuals, documents, code samples, and other reference materials.

In some examples and features of the instant solution, upon receiving the script associated with the first automation framework, the instant solution parses it to identify subsets of code. It generates an initial prompt that includes instructions for converting the script into a form compatible with the second automation framework. This prompt guides the first AI model in performing the initial conversion. After converting the script, the instant solution performs a rigorous comparison against the stored verification criteria, including the entity's coding standards. If the converted script does not meet these standards, the instant solution flags the errors and displays the issues via the GUI. To address these errors, the instant solution generates an additional prompt using the second AI model. This new prompt is generated by executing the second AI model on the original prompt, the initial converted script, and one or more documents defining the coding standards of the entity. This ensures that the new prompt incorporates specific instructions derived from the entity's coding standards, providing more precise guidance for the re-engineering of the script. The instant solution then uses the first AI model to execute this additional prompt on the original script, generating an updated converted script. This iterative process continues until the converted script meets all the verification criteria, including the entity-specific coding standards, or until a predetermined iteration threshold is reached.

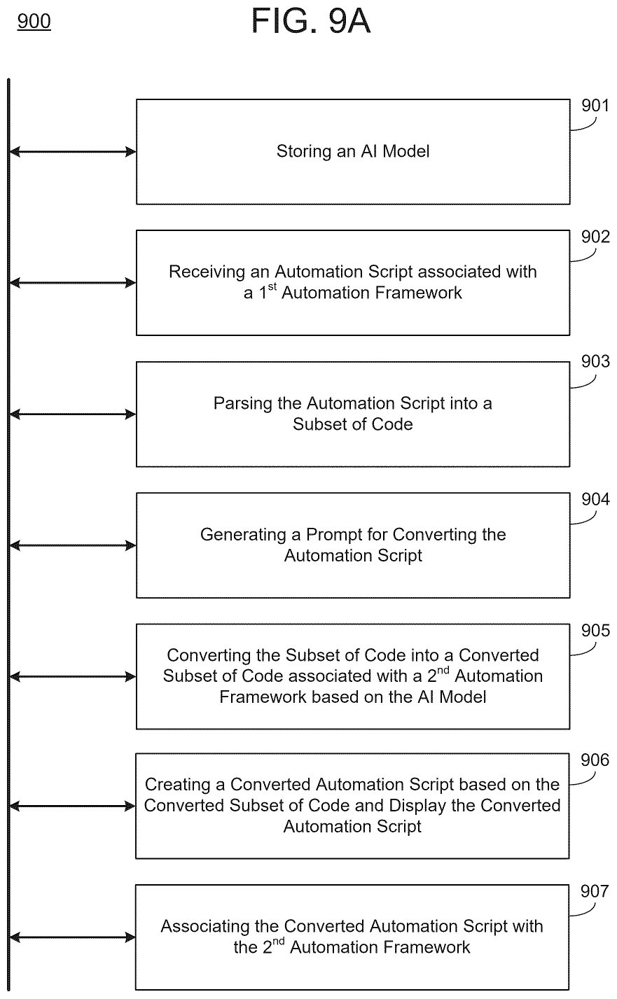

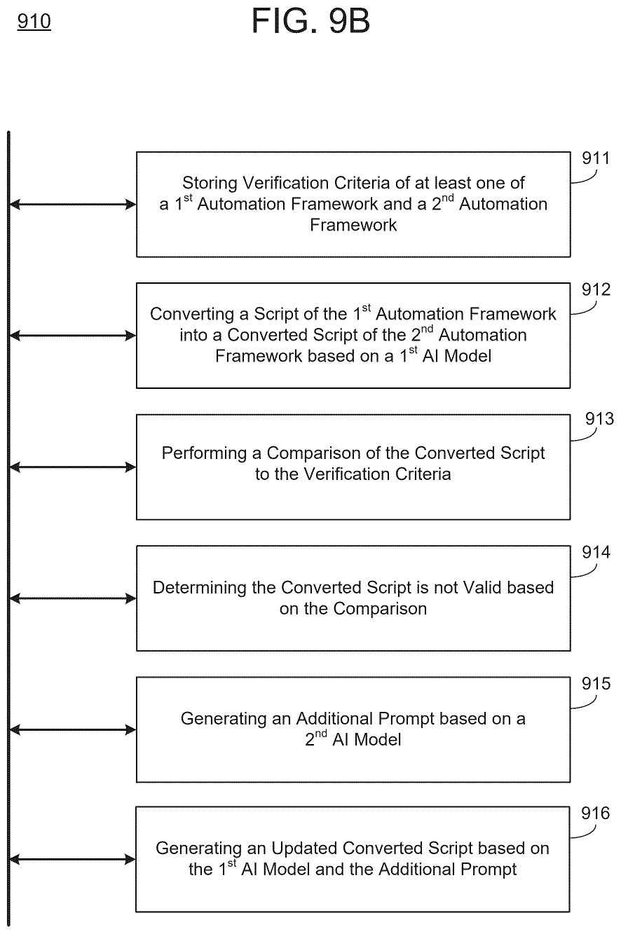

FIG. 9A illustrates a method 900 of migrating an automation script from a first automation framework to a second automation framework according to examples and features of the instant solution. As an example, the method 900 may be performed by a computing system, a software application, a server, a cloud platform, a combination of systems, and the like. Referring to FIG. 9A, in 901, the method may include storing an artificial intelligence (AI) model in a memory. In 902, the method may include receiving an automation script of a software test that is associated with a first automation framework. In 903, the method may include parsing the automation script to identify a subset of code for the software test. In 904, the method may include generating a prompt which includes instructions for converting the automation script into a form associated with a second automation framework. In 905 the method may include converting the subset of code into a converted subset of code that is associated with the second automation framework based on execution of the AI model on the prompt and the subset of code. In 906, the method may include creating a converted automation script based on the converted subset of code and displaying the converted automation script via a GUI. In 907, the method may include associating the converted automation script with the second automation framework.

In some examples and features of the instant solution, the parsing may include parsing the automation script into a plurality of subsets of code, and the converting may include converting the plurality of subsets of code into a plurality of converted subsets of code based on a plurality of executions of the AI model on the prompt, respectively. In some examples and features of the instant solution, the method may further include generating an application programming interface (API) call which includes the prompt and the subset of code and transmitting the API call to an API of the AI model.

In some examples and features of the instant solution, the generating the prompt may include generating the prompt with instructions regarding at least one of comments associated with the first automation framework, documentation associated with the first automation framework, and formatting associated with the first automation framework into the prompt. In some examples and features of the instant solution, the method may further include retrieving the automation script of the software test that is associated with the first automation framework from a first storage associated with the first automation framework based on a schedule, storing the converted automation script in a second storage associated with the second automation framework, and configuring the second automation framework to find the converted automation script within the second storage.

In some examples and features of the instant solution, the generating the prompt may include generating the prompt with instructions about a coding standard of a particular entity, and the converting may include converting the subset of code into the converted subset of code based on the coding standard of the particular entity. In some examples and features of the instant solution, the method may further include receiving a command submitted via the GUI, wherein the parsing of the automation script and the generating of the prompt are performed in response to receipt of the command submitted via the GUI. In some examples and features of the instant solution, the method may further include exporting the automation script of the software test that is associated with the first automation framework from the first automation framework in a native programming language and converting the automation script from the native programming language into an extensible markup language (XML) prior to parsing the automation script.

FIG. 9B illustrates a method 910 of iteratively optimizing a converted automation script according to examples and features of the instant solution. As an example, the method 910 may be performed by a computing system, a software application, a server, a cloud platform, a combination of systems, and the like. Referring to FIG. 9B, in 911, the method may include storing verification criteria associated with at least one of a first automation framework and a second automation framework in a memory device. In 912, the method may include converting a script associated with the first automation framework into a converted script associated with the second automation framework based on execution of a first artificial intelligence (AI) model on a prompt and the script. In 913, the method may include performing a comparison of the converted script to the verification criteria. In 914, the method may include determining that the converted script is not valid based on the comparison of the converted script to the verification criteria. In 915, the method may include generating an additional prompt with instructions to re-engineer the converted script based on execution of a second AI model on the prompt and the converted script. In 916, the method may include generating an updated converted script based on execution of the first AI model on the additional prompt and the script.

In some examples and features of the instant solution, the performing may include performing the comparison of the converted script based on a predetermined formatting criteria of the second automation framework and the determining may include determining that the converted script is not valid based on the predetermined formatting criteria of the second automation framework and displaying a result of the comparison of the converted script and the determination that the script is not valid. In some examples and features of the instant solution, the performing may include performing the comparison of the converted script based on a coding standard of an entity associated with the second automation framework and the determining may include determining that the converted script is not valid based on the coding standard of the entity associated with the second automation framework. In some examples and features of the instant solution, the performing may include performing the comparison of the converted script based on logic included in the script associated with the first automation framework and the determining may include determining that the converted script is not valid based on the logic included in the script associated with the first automation framework.

In some examples and features of the instant solution, the method may include tracking a number of iterations performed, and in response to the number of iterations being below a predetermined threshold, continuing to generate the updated converted script. In some examples and features of the instant solution, the method may include tracking a number of iterations performed, and in response to the number of iterations reaching a predetermined threshold, terminating execution of the AI model and the second AI model and at least one of logging a notification and displaying the notification via the GUI. In some examples and features of the instant solution, the generating the additional prompt may include generating the additional prompt with instructions to re-engineer the converted script based on execution of the second AI model on one or more documents that define a coding standard of an entity associated with the second automation framework.

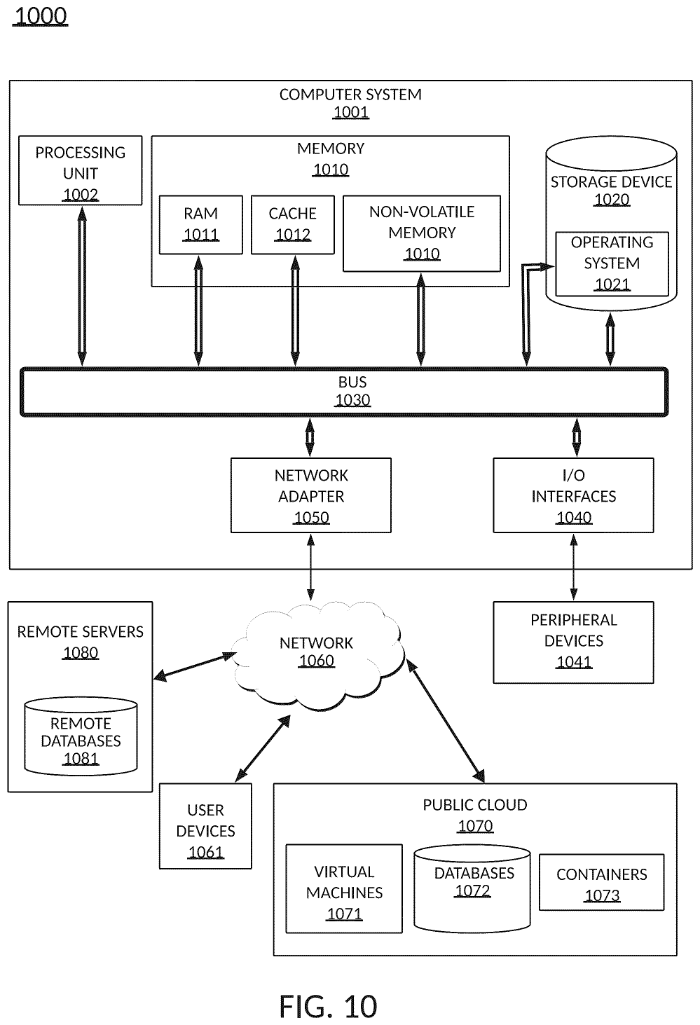

The examples and features of the instant solution may be implemented in one or more of the elements described or depicted herein, including for example, the elements described or depicted in FIG. 10. These examples and features may further be implemented in hardware, in a computer program executed by a processor, in firmware, or in a combination of the above. A computer program may be embodied on a computer readable medium, such as a storage medium. For example, a computer program may reside in random access memory (RAM), flash memory, read-only memory (ROM), erasable programmable read-only memory (EPROM), electrically erasable programmable read-only memory (EEPROM), registers, hard disk, a removable disk, a compact disk read-only memory (CD-ROM), or any other form of storage medium known in the art.

An exemplary storage medium may be communicatively coupled to the processor such that the processor may read information from, and write information to, the storage medium. In the alternative, the storage medium may be integral to the processor. The processor and the storage medium may reside in an application specific integrated circuit (ASIC). In the alternative, the processor and the storage medium may reside as discrete components. For example, FIG. 10 illustrates an example computer system architecture, which may represent or be integrated in any of the above-described components, etc.

FIG. 10 illustrates a computing environment according to the instant solution's example features, structures, or characteristics. FIG. 10 is not intended to suggest any limitation as to the scope of use or functionality of features, structures, or characteristics of the instant solution of the application described herein. Regardless, the computing environment 1000 can be implemented to perform any of the functionalities described herein. In computing environment 1000, there is a computer system 1001, operational within numerous other general-purpose or special-purpose computing system environments or configurations.

Computer system 1001 may take the form of a desktop computer, laptop computer, tablet computer, smartphone, smartwatch or other wearable computer, server computer system, thin client, thick client, network computer system, minicomputer system, mainframe computer, quantum computer, and distributed cloud computing environment that include any of the described systems or devices, and the like or any other form of computer or mobile device now known or to be developed in the future that is capable of running a program, accessing a network 1060 or querying a database. Depending upon the technology, the performance of a computer-implemented method may be distributed among multiple computers and among multiple locations. However, in this presentation of the computing environment 1000, a detailed discussion is focused on a single computer, specifically computer system 1001, to keep the presentation as simple as possible.

Computer system 1001 may be located in a cloud, even though it is not shown in a cloud in FIG. 10. On the other hand, computer system 1001 may not be in a cloud except to any extent as may be affirmatively indicated. Computer system 1001 may be described in the general context of computer system-executable instructions, such as program modules, executed by a computer system 1001. Generally, program modules may include routines, programs, objects, components, logic, data structures, and so on that perform tasks or implement certain abstract data types. As shown in FIG. 10, computer system 1001 in computing environment 1000 is shown in the form of a general-purpose computing device. The components of computer system 1001 may include but are not limited to, at least one processor or processing unit 1002, a system memory 1010, and a bus 1030 that couples various system components, including system memory 1010 to processing unit 1002.

Processing unit 1002 includes at least one computer processor of any type now known or to be developed. The processing unit 1002 may contain circuitry distributed over multiple integrated circuit chips. The processing unit 1002 may also implement multiple processor threads and multiple processor cores. Cache 1012 is a memory that may be in the processor chip package(s) or located “off-chip,” as depicted in FIG. 10. Cache 1012 is typically used for data or code accessed by the threads or cores running on the processing unit 1002. In some computing environments, processing unit 1002 may be designed to work with qubits and perform quantum computing.

Memory 1010 is any volatile memory now known or to be developed in the future. Examples include dynamic random-access memory (RAM) 1011 or static type RAM 1011. Typically, the volatile memory is characterized by random access, but this may not be the characterization unless affirmatively indicated. In computer system 1001, memory 1010 is in a single package. It is internal to computer system 1001, but alternatively or additionally, the volatile memory may be distributed over multiple packages and/or located externally with respect to computer system 1001. By way of example, memory 1010 can be provided for reading from and writing to a non-removable, non-volatile magnetic media (shown as storage device 1020, and typically called a “hard drive”). Memory 1010 may include at least one program product having a set (e.g., at least one) of program modules configured to carry out the functions of various features, structures, or characteristics of the instant solution of the application. A typical computer system 1001 may include cache 1012, a specialized volatile memory generally faster than RAM 1011 and generally located closer to the processing unit 1002. Cache 1012 stores frequently accessed data and instructions accessed by the processing unit 1002 to speed up processing time. The computer system 1001 may also include non-volatile memory 1013 in the form of ROM, PROM, EEPROM, and flash memory. Non-volatile memory 1013 often contains programming instructions for starting the computer, including the basic input/output system (BIOS) and information to start the operating system 1021.

Computer system 1001 may include a removable/non-removable, volatile/non-volatile computer storage device 1020. For example, storage device 1020 can be a non-removable, non-volatile magnetic media (not shown and typically called a “hard drive”). At least one data interface can connect it to the bus 1030. In features, structures, or characteristics of the instant solution where computer system 1001 has a large amount of storage (for example, where computer system 1001 locally stores and manages a large database), then this storage may be provided by peripheral storage devices 1020 designed for storing very large amounts of data, such as a storage area network (SAN) that is shared by multiple, geographically distributed computers.

The operating system 1021 is software that manages computer system 1001 hardware resources and provides common services for computer programs. Operating system 1021 may take several forms, such as various known proprietary operating systems or open-source Portable Operating System Interface type operating systems that employ a kernel.

The bus 1030 represents at least one of several types of bus structures, including a memory bus or memory controller, a peripheral bus, an accelerated graphics port, and a processor or local bus using various bus architectures. By way of example, and not limitation, such architectures include Industry Standard Architecture (ISA) buses, Micro Channel Architecture (MCA) buses, Enhanced ISA (EISA) buses, Video Electronics Standards Association (VESA) local buses, and Peripheral Component Interconnect (PCI) bus. The bus 1030 is the signal conduction path that allows the various components of computer system 1001 to communicate.

Computer system 1001 may communicate with at least one peripheral device, 1041, via an input/output (I/O) interface, 1040. Such devices may include a keyboard, a pointing device, a display, etc.; at least one device that enables a user to interact with computer system 1001; and/or any devices (e.g., network card, modem, etc.) that enable computer system 1001 to communicate with at least one other computing devices. Such communication can occur via I/O interface 1040. As depicted, I/O interface 1040 communicates with the other components of computer system 1001 via bus 1030.

Network adapter 1050 enables the computer system 1001 to connect and communicate with at least one network 1060, such as a local area network (LAN), a wide area network (WAN), and/or a public network (e.g., the Internet). It bridges the computer's internal bus 1030 and the external network, exchanging data efficiently and reliably. The network adapter 1050 may include hardware, such as modems or Wi-Fi signal transceivers, and software for packetizing and/or de-packetizing data for communication network transmission. Network adapter 1050 supports various communication protocols to ensure compatibility with network standards. Ethernet connections adhere to protocols such as IEEE 802.3, while wireless communications might support IEEE 802.11 standards, Bluetooth, near-field communication (NFC), or other network wireless radio standards.

Network 1060 is any computer network that can receive and/or transmit data. Network 1060 can include a WAN, LAN, private cloud, or public Internet, capable of communicating computer data over non-local distances by any technology that is now known or to be developed in the future. Any connection depicted can be wired and/or wireless and may traverse other components that are not shown. In some features, structures, or characteristics of the instant solution, a network 1060 may be replaced and/or supplemented by LANs designed to communicate data between devices in a local area, such as a Wi-Fi network. The network 1060 typically includes computer hardware such as copper transmission cables, optical transmission fibers, wireless transmission, routers, firewalls, switches, gateway computers, edge servers, and network infrastructure known now or to be developed in the future. Computer system 1001 connects to network 1060 via network adapter 1050 and bus 1030.

User devices 1061 are any computer systems used and controlled by an end user in connection with computer system 1001. For example, in a hypothetical case where computer system 1001 is designed to provide a recommendation to an end user, this recommendation may typically be communicated from network adapter 1050 of computer system 1001 through network 1060 to a user device 1061, allowing user device 1061 to display, or otherwise present, the recommendation to an end user. User devices can be a wide array, including personal computers, laptops, tablets, hand-held, mobile phones, etc.

A public cloud 1070 is an on-demand availability of computer system resources, including data storage and computing power, without direct active management by the user. Public clouds 1070 are often distributed, with data centers in multiple locations for availability and performance. Computing resources on public clouds 1070 are shared across multiple tenants through virtual computing environments comprising virtual machines 1071, databases 1072, containers 1073, and other resources. A container 1073 is an isolated, lightweight software for running a software application on the host operating system 1021. Containers 1073 are built on top of the host operating system's kernel and contain software applications and some lightweight operating system APIs and services. In contrast, virtual machine 1071 is a software layer with an operating system 1021 and kernel. Virtual machines 1071 are built on top of a hypervisor emulation layer designed to abstract a host computer's hardware from the operating software environment. Public clouds 1070 generally offers databases 1072, abstracting high-level database management activities. At least one element described or depicted in FIG. 10 can perform at least one of the actions, functionalities, or features described or depicted herein.

Remote servers 1080 are any computers that serve at least some data and/or functionality over a network 1060, for example, WAN, a virtual private network (VPN), a private cloud, or via the Internet to computer system 1001. These networks 1060 may communicate with a LAN to reach users. The user interface may include a web browser or a software application that facilitates communication between the user and remote data. Such software applications have been referred to as “thin” desktop software applications or “thin clients.” Thin clients typically incorporate software programs to emulate desktop sessions. Mobile device software applications can also be used. Remote servers 1080 can also host remote databases 1081, with the database located on one remote server 1080 or distributed across multiple remote servers 1080. Remote databases 1081 are accessible from database client applications installed locally on the remote server 1080, other remote servers 1080, user devices 1061, or computer system 1001 across a network 1060. An AI/ML model described or depicted here may reside fully or partially on any of the elements described or depicted in FIG. 10.

Although an exemplary example of the instant solution of at least one of an apparatus, method, and computer readable medium has been illustrated in the accompanying drawings and described in the foregoing detailed description, it will be understood that the instant solution is not limited to the examples of the instant solution disclosed but is capable of numerous rearrangements, modifications, and substitutions as set forth and defined by the following claims. For example, the instant solution's capabilities of the various figures can be performed by one or more of the modules or components described herein or in a distributed architecture and may include a transmitter, receiver, or pair of both. For example, all or part of the functionality performed by the individual modules may be performed by one or more of these modules. Further, the functionality described herein may be performed at various times and in relation to various events, internal or external to the modules or components. Also, the information sent between various modules can be sent between the modules via at least one of a data network, the Internet, a voice network, an Internet Protocol network, a wireless device, a wired device and/or via a plurality of protocols. Also, the messages sent or received by any of the modules may be sent or received directly and/or via one or more of the other modules.

One skilled in the art will appreciate that the instant solution may be embodied as a personal computer, a server, a console, a personal digital assistant (PDA), a cell phone, a tablet computing device, a smartphone, or any other suitable computing device, or combination of devices. Presenting the above-described functions as being performed by the instant solution is not intended to limit the scope of the present instant solution in any way but is intended to provide one example of the many examples of the instant solution. Indeed, methods, systems, and apparatuses disclosed herein may be implemented in localized and distributed forms consistent with computing technology.

It should be noted that some of the instant solution features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module may not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory, tape, or any other such medium used to store data.

Indeed, a module of executable code may be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the instant solution, as generally described and illustrated in the figures herein, may be arranged and designed in a wide variety of different configurations. Thus, the detailed descriptions of the instant solution and the examples and features of the instant solution are not intended to limit the scope of the instant solution as claimed but are merely representative examples of the instant solution.

One having ordinary skill in the art will readily understand that the above may be practiced with steps in a different order and/or with hardware elements in configurations that are different from those which are disclosed. Therefore, although the instant solution has been described based upon these preferred examples and features of the instant solution, it would be apparent to those of skill in the art that certain modifications, variations, and alternative constructions would be apparent.

While preferred examples of the present instant solution have been described, it is to be understood that the examples described are illustrative only, and the scope of the instant solution is to be defined solely by the appended claims when considered with a full range of equivalents and modifications (e.g., protocols, hardware devices, software platforms, etc.) thereto.

What is claimed is:

1. An apparatus, comprising:
a memory configured to store verification criteria associated with at least one of a first automation framework and a second automation framework; and
a processor configured to iteratively:
convert a script associated with the first automation framework into a converted script associated with the second automation framework based on execution of a first artificial intelligence (AI) model on a prompt and the script,
perform a comparison of the converted script to the verification criteria,
determine that the converted script is not valid based on the comparison of the converted script to the verification criteria,
generate an additional prompt with instructions to re-engineer the converted script based on execution of a second AI model on the prompt and the converted script, and
generate an updated converted script based on execution of the first AI model on the additional prompt and the script.

2. The apparatus of claim 1, wherein the processor is configured to:
perform the comparison of the converted script based on a predetermined formatting criteria of the second automation framework and determine that the converted script is not valid based on the predetermined formatting criteria of the second automation framework, and
display a result of the comparison of the converted script and the determination that the converted script is not valid.

3. The apparatus of claim 1, wherein the processor is configured to perform the comparison of the converted script based on a coding standard of an entity associated with the second automation framework and determine that the converted script is not valid based on the coding standard of the entity associated with the second automation framework.

4. The apparatus of claim 1, wherein the processor is configured to perform the comparison of the converted script based on logic included in the script associated with the first automation framework and determine that the converted script is not valid based on the logic included in the script associated with the first automation framework.

5. The apparatus of claim 1, wherein the processor is further configured to track a number of iterations performed, and in response to the number of iterations being below a predetermined threshold, continue to generate the updated converted script.

6. The apparatus of claim 1, wherein the processor is further configured to track a number of iterations performed, and in response to the number of iterations reaching a predetermined threshold, terminate execution of the first AI model and the second AI model and at least one of log a notification and display the notification via the GUI.

7. The apparatus of claim 1, wherein the processor is further configured to generate the additional prompt with instructions to re-engineer the converted script based on execution of the second AI model on one or more documents that define a coding standard of an entity associated with the second automation framework.

8. A method comprising:
storing verification criteria associated with at least one of a first automation framework and a second automation framework in a memory device;
converting a script associated with the first automation framework into a converted script associated with the second automation framework based on execution of a first artificial intelligence (AI) model on a prompt and the script;
performing a comparison of the converted script to the verification criteria;
determining that the converted script is not valid based on the comparison of the converted script to the verification criteria;
generating an additional prompt with instructions to re-engineer the converted script based on execution of a second AI model on the prompt and the converted script; and
generating an updated converted script based on execution of the first AI model on the additional prompt and the script.

9. The method of claim 8, wherein the performing comprises:
performing the comparison of the converted script based on a predetermined formatting criteria of the second automation framework and the determining comprises determining that the converted script is not valid based on the predetermined formatting criteria of the second automation framework; and
displaying a result of the comparison of the converted script and the determination that the converted script is not valid.

10. The method of claim 8, wherein the performing comprises performing the comparison of the converted script based on a coding standard of an entity associated with the second automation framework and the determining comprises determining that the converted script is not valid based on the coding standard of the entity associated with the second automation framework.

11. The method of claim 8, wherein the performing comprises performing the comparison of the converted script based on logic included in the script associated with the first automation framework and the determining comprises determining that the converted script is not valid based on the logic included in the script associated with the first automation framework.

12. The method of claim 8, comprising tracking a number of iterations performed, and in response to the number of iterations being below a predetermined threshold, continuing to generate the updated converted script.

13. The method of claim 8, comprising tracking a number of iterations performed, and in response to the number of iterations reaching a predetermined threshold, terminating execution of the first AI model and the second AI model and at least one of logging a notification and displaying the notification via the GUI.

14. The method of claim 8, wherein the generating the additional prompt comprises generating the additional prompt with instructions to re-engineer the converted script based on execution of the second AI model on one or more documents that define a coding standard of an entity associated with the second automation framework.

15. A computer-readable storage medium comprising instructions which when executed by a computer cause a processor to perform:
storing verification criteria associated with at least one of a first automation framework and a second automation framework in a memory device;
converting a script associated with the first automation framework into a converted script associated with the second automation framework based on execution of a first artificial intelligence (AI) model on a prompt and the script;
performing a comparison of the converted script to the verification criteria;
determining that the converted script is not valid based on the comparison of the converted script to the verification criteria;
generating an additional prompt with instructions to re-engineer the converted script based on execution of a second AI model on the prompt and the converted script; and
generating an updated converted script based on execution of the first AI model on the additional prompt and the script.

16. The computer-readable storage medium of claim 15, wherein the performing comprises:
performing the comparison of the converted script based on a predetermined formatting criteria of the second automation framework and the determining comprises determining that the converted script is not valid based on the predetermined formatting criteria of the second automation framework; and
displaying a result of the comparison of the converted script and the determination that the converted script is not valid.

17. The computer-readable storage medium of claim 15, wherein the performing comprises performing the comparison of the converted script based on a coding standard of an entity associated with the second automation framework and the determining comprises determining that the converted script is not valid based on the coding standard of the entity associated with the second automation framework.

18. The computer-readable storage medium of claim 15, wherein the performing comprises performing the comparison of the converted script based on logic included in the script associated with the first automation framework and the determining comprises determining that the converted script is not valid based on the logic included in the script associated with the first automation framework.

19. The computer-readable storage medium of claim 15, wherein the processor is further configured to perform tracking a number of iterations performed, and in response to the number of iterations being below a predetermined threshold, continuing to generate the updated converted script.

20. The computer-readable storage medium of claim 15, wherein the processor is further configured to perform tracking a number of iterations performed, and in response to the number of iterations reaching a predetermined threshold, terminating execution of the first AI model and the second AI model and at least one of logging a notification and displaying the notification via the GUI.
